(19) United States
(12) Patent Application Publication
(10) Pub. No.: US 2026/0239438 A1
(43) Pub. Date: Aug. 13, 2026

(54) REQUIREMENT FOR RECEPTION

(71) Applicant: LG ELECTRONICS INC., Seoul (KR)

(72) Inventors: Yoonoh YANG, Seoul (KR); Seungmin WOO, Seoul (KR); Sangwook LEE, Seoul (KR); Jinyup HWANG, Seoul (KR); Ilnam CHO, Seoul (KR)

(73) Assignee: LG ELECTRONICS INC., Seoul (KR)

(21) Appl. No.: 19/154,463

(22) PCT Filed: Feb. 7, 2024
(86) PCT No.: PCT/KR2024/001785

§ 371 Date: Aug. 7, 2025

Related U.S. Application Data
(60) Provisional application No. 63/443,724, filed on Feb. 7, 2023.
(60) Provisional application No. 63/443,725, filed on Feb. 7, 2023.
(60) Provisional application No. 63/457,417, filed on Apr. 6, 2023.
(60) Provisional application No. 63/465,821, filed on May 11, 2023.
(60) Provisional application No. 63/532,035, filed on Aug. 10, 2023.
(60) Provisional application No. 63/540,377, filed on Sep. 26, 2023.
(60) Provisional application No. 63/546,931, filed on Nov. 2, 2023.

(51) Int. Cl. H04W 74/0833; H04B 7/06; H04B 7/08; H04W 8/22

(52) U.S. Cl. CPC H04W 74/0833; H04B 7/06968; H04B 7/086; H04W 8/22

(57) ABSTRACT

The present disclosure provides a UE. The UE includes at least one transceiver; at least one processor; and at least one memory that stores instructions and is operatively electrically connectable with the at least one processor. Operations performed based on the command being executed by the at least one processor may include: transmitting random access preamble to a base station; and receiving response from the base station.

### CROSS-REFERENCE TO RELATED APPLICATIONS

This application is the National Stage filing under 35 U.S.C. 371 of International Application No. PCT/KR2024/001785, filed on Feb. 7, 2024, which claims the benefit of U.S. Provisional Application Nos. 63/443,724 filed on Feb. 7, 2023, 63/443,725 filed on Feb. 7, 2023, 63/457,417 filed on Apr. 6, 2023, 63/465,821 filed on May 11, 2023, 63/532,035 filed on Aug. 10, 2023, 63/540,377 filed on Sep. 26, 2023, and 63/546,931 filed Nov. 2, 2023, the contents of which are all hereby incorporated by reference herein in their entireties.

### TECHNICAL FIELD

The present specification relates to a radio communication.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 110 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

User Equipment (UE) receiving signals from multiple directions has been discussed. However, prior art has not defined requirements for such UEs to receive signals simultaneously. This leads to the problem that the UEs do not receive the signals accurately and/or efficiently.

### SUMMARY

In one aspect, a UE is provided. The UE includes at least one transceiver; at least one processor; and at least one memory that stores instructions and is operatively electrically connectable with the at least one processor. Operations performed based on the command being executed by the at least one processor may include: transmitting random access preamble to a base station; and receiving response from the base station.

In another aspect, a method performed by the UE is provided.

In one aspect, a base station is provided. The base station includes at least one transceiver; at least one processor; and at least one memory that stores instructions and is operatively electrically connectable with the at least one processor. Operations performed based on the command being executed by the at least one processor may include: receiving random access preamble from a UE; and transmitting response to the UE.

In another aspect, a method by which the base station performs is provided.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 is a diagram showing an example of a communication structure that can be provided in a 6G system.

FIG. 5 shows an example of an electromagnetic spectrum.

FIGS. 6a through 6e shows an example of RACH procedures applicable to an embodiment of the present disclosure.

FIGS. 7a to 7c illustrate examples of possible example of 2 panel placements according to an embodiment of the present disclosure.

FIG. 8 illustrates examples of 2 panel placements according to an embodiment of the present disclosure.

FIG. 9 illustrates examples of CDF of antenna beam gain for the activated one panel according to an embodiment of the present disclosure.

FIG. 10 illustrates examples of AoA of simultaneous 2 different Rx directions according to an embodiment of the present disclosure.

FIGS. 11a to 11d illustrate examples of Rx Beam gain of AoA pair for simultaneous 2 different Rx directions according to an embodiment of the present disclosure.

FIG. 12 illustrates examples of different AoA pairs according to an embodiment of the present disclosure.

FIGS. 13a and 13b illustrate examples of test points and rotation method for 2AoAs according to an embodiment of the present disclosure.

FIGS. 14a and 14b illustrate examples of Pass Ratio of both ‘OR combining’ and ‘averaging’ for Case 1 according to an embodiment of the present disclosure.

FIGS. 15a and 15b illustrate examples of Pass Ratio of both ‘OR combining’ and ‘averaging’ for Case 2 according to an embodiment of the present disclosure.

FIGS. 16a and 16b illustrate examples of Pass Ratio of both ‘OR combining’ and ‘averaging’ for Case 3 according to an embodiment of the present disclosure.

FIGS. 17a and 17b illustrate examples of Pass Ratio of both ‘OR combining’ and ‘arithmetic mean for Case 1 of Case 6 according to an embodiment of the present disclosure.

FIGS. 18a and 18b illustrate examples of Pass Ratio of both ‘OR combining’ and ‘arithmetic mean for Case 2 of Case 6 according to an embodiment of the present disclosure.

FIGS. 19a and 19b illustrate examples of Pass Ratio of both ‘OR combining’ and ‘arithmetic mean for Case 3 of Case 6 according to an embodiment of the present disclosure.

FIG. 20 illustrates an example of an operation according to an embodiment of the present disclosure.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. Evolution of 3GPP LTE includes LTE-A (advanced), LTE-A Pro, and/or 5G NR (new radio).

For convenience of description, implementations of the present disclosure are mainly described in regard to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

Although a user equipment (UE) is illustrated by way of example in the accompanying drawings, the illustrated UE may be referred to as a terminal, mobile equipment (ME), and the like. In addition, the UE may be a portable device such as a notebook computer, a mobile phone, a PDA, a smartphone, and a multimedia device or may be a non-portable device such as a PC or a vehicle-mounted device.

Hereinafter, a UE is used as an example of a wireless communication device (or a wireless device or wireless equipment) capable of wireless communication. An operation performed by a UE may be performed by a wireless communication device. A wireless communication device may also be referred to as a wireless device, wireless equipment, or the like. Hereinafter, AMF may mean an AMF node, SMF may mean an SMF node, and UPF may mean a UPF node.

A base station used below generally refers to a fixed station communicating with a wireless device and may also be referred as an evolved-NodeB (eNodeB), an evolved-NodeB (eNB), a base transceiver system (BTS), an access point, and a next generation NodeB (gNB).

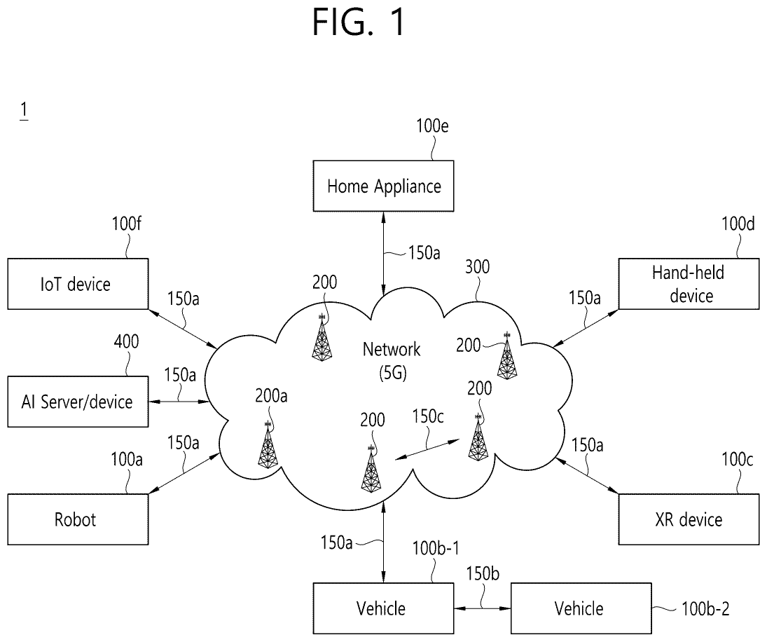

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW). FR2 may include FR 2-1 and FR 2-2, as shown in the examples in Table 1 and Table 2.

TABLE 1

| Frequency Range | | Corresponding | |
|---|---|---|---|
| designation | | frequency range | Subcarrier Spacing |
| FR1 | | 450 MHz-6000 MHz | 15, 30, 60 kHz |
| FR2 | FR2-1 | 24250 MHz-52600 MHz | 60, 120, 240 kHz |
| | FR2-2 | 57000 MHz-71000 MHz | 120, 480, 960 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | | Corresponding | |
|---|---|---|---|
| designation | | frequency range | Subcarrier Spacing |
| FR1 | | 410 MHz-7125 MHz | 15, 30, 60 kHz |
| FR2 | FR2-1 | 24250 MHz-52600 MHz | 60, 120, 240 kHz |
| | FR2-2 | 57000 MHz-71000 MHz | 120, 480, 960 kHz |

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally, and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally, and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

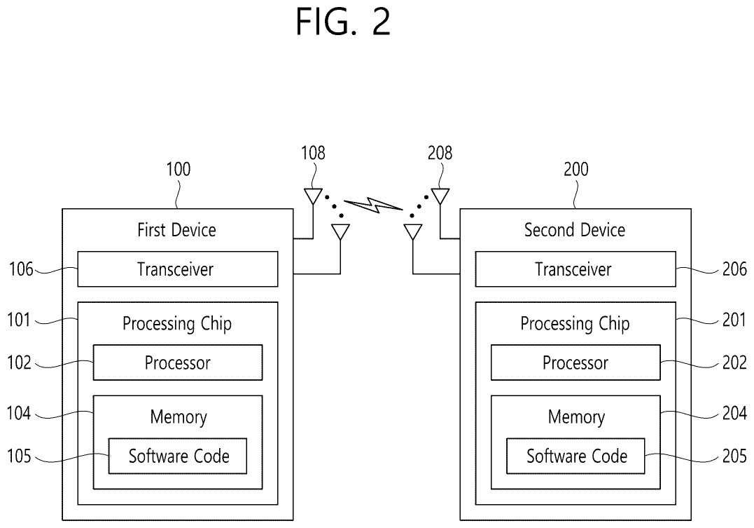

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with radio frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

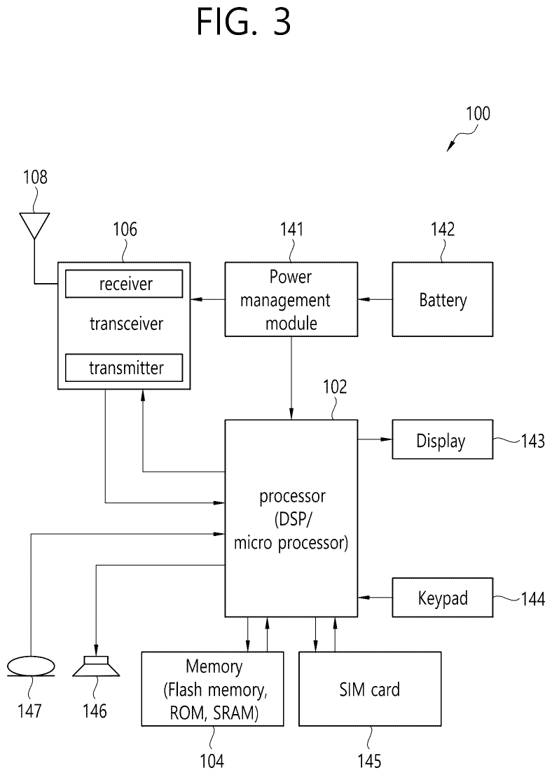

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory unit 130 may be configured by a RAM, a DRAM, a ROM, a flash memory, a volatile memory, a non-volatile memory, and/or a combination thereof.

### <Operating Bands of NR>.

The operating bands in NR are as follows

The operating bands in Table 3 below are the refarmed operating bands from the operating bands of LTE/LTE-A. This is referred to as the FR1 band.

TABLE 3

| NR | Uplink (UL) | Downlink(DL) | |
|---|---|---|---|
| operating | operating band | operating band | Duplex |
| bands | F_{UL}_{_{—}}_{low}-F_{UL}_{_{—}}_{high} | F_{DL}_{_{—}}_{low}-F_{DL}_{_{—}}_{high} | Mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n5 | 824 MHz-849 MHz | 869 MHz-894 MHz | FDD |
| n7 | 2500 MHz-2570 MHz | 2620 MHz-2690 MHz | FDD |
| n8 | 880 MHz-915 MHz | 925 MHz-960 MHz | FDD |
| n12 | 699 MHz-716 MHz | 729 MHz-746 MHz | FDD |
| n20 | 832 MHz-862 MHz | 791 MHz-821 MHz | FDD |
| n25 | 1850 MHz-1915 MHz | 1930 MHz-1995 MHz | FDD |
| n28 | 703 MHz-748 MHz | 758 MHz-803 MHz | FDD |
| n34 | 2010 MHz-2025 MHz | 2010 MHz-2025 MHz | TDD |
| n38 | 2570 MHz-2620 MHz | 2570 MHz-2620 MHz | TDD |
| n39 | 1880 MHz-1920 MHz | 1880 MHz-1920 MHz | TDD |
| n40 | 2300 MHz-2400 MHz | 2300 MHz-2400 MHz | TDD |
| n41 | 2496 MHz-2690 MHz | 2496 MHz-2690 MHz | TDD |
| n50 | 1432 MHz-1517 MHz | 1432 MHz-1517 MHz | TDD1 |
| n51 | 1427 MHz-1432 MHz | 1427 MHz-1432 MHz | TDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n74 | 1427 MHz-1470 MHz | 1475 MHz-1518 MHz | FDD |
| n75 | N/A | 1432 MHz-1517 MHz | SDL |
| n76 | N/A | 1427 MHz-1432 MHz | SDL |
| n77 | 3300 MHz-4200 MHz | 3300 MHz-4200 MHz | TDD |
| n78 | 3300 MHz-3800 MHz | 3300 MHz-3800 MHz | TDD |
| n79 | 4400 MHz-5000 MHz | 4400 MHz-5000 MHz | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |
| n86 | 1710 MHz-1780 MHz | N/A | SUL |

The table below shows the NR operating band defined at high frequencies. This is called the FR2 band.

TABLE 4

| NR | Uplink (UL) | Downlink(DL) | |
|---|---|---|---|
| Operating | operating band | operating band | Duplex |
| band | F_{UL}_{_{—}}_{low}-F_{UL}_{_{—}}_{high} | F_{DL}_{_{—}}_{low}-F_{DL}_{_{—}}_{high} | Mode |
| n257 | 26500 MHz-29500 MHz | 26500 MHz-29500 MHz | TDD |
| n258 | 24250 MHz-27500 MHz | 24250 MHz-27500 MHz | TDD |
| n259 | 37000 MHz-40000 MHz | 37000 MHz-40000 MHz | TDD |
| n260 | 37000 MHz-40000 MHz | 37000 MHz-40000 MHz | FDD |
| n261 | 27500 MHz-28350 MHz | 27500 MHz-28350 MHz | FDD |

### <6G System General>

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 4 shows the requirements of the 6G system.

TABLE 5

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

The 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

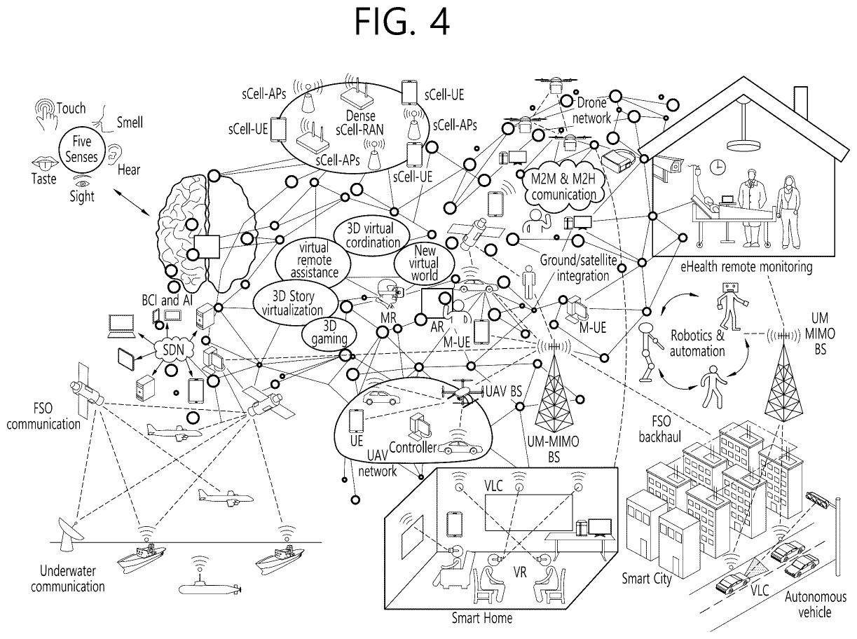

FIG. 4 is a diagram showing an example of a communication structure that can be provided in a 6G system.

The 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimemtion connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduces costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

### <Core Implementation Technology of 6G System>

### Artificial Intelligence

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. In addition, machine learning may be used for antenna selection, power control, symbol detection, etc. in the MIMO system.

Machine learning refers to a series of operations to train a machine in order to create a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method, a recurrent Boltzmman machine (RNN) method and a spiking neural network (SNN). Such a learning model is applicable.

### THz (Terahertz) Communication

A data rate may increase by increasing bandwidth. This may be performed by using sub-TH communication with wide bandwidth and applying advanced massive MIMO technology. THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

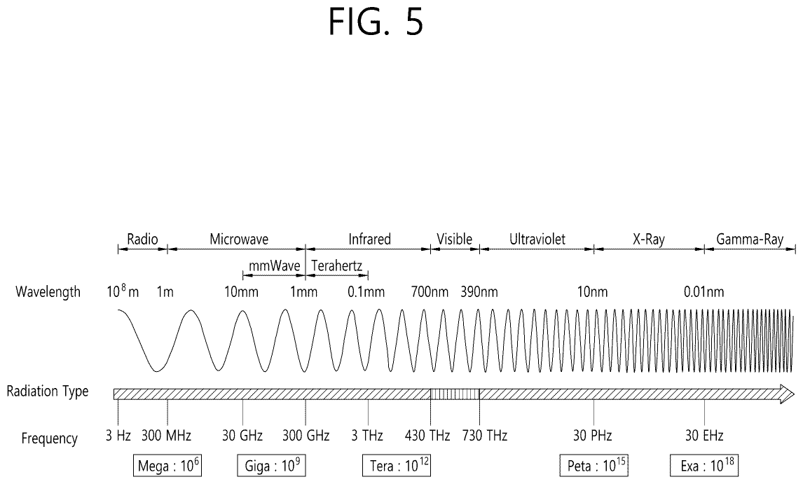

FIG. 5 shows an example of an electromagnetic spectrum.

The main characteristics of THz communication include (i) bandwidth widely available to support a very high data rate and (ii) high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### Large-Scale MIMO

One of core technologies for improving spectrum efficiency is MIMO technology. When MIMO technology is improved, spectrum efficiency is also improved. Accordingly, massive MIMO technology will be important in the 6G system. Since MIMO technology uses multiple paths, multiplexing technology and beam generation and management technology suitable for the THz band should be significantly considered such that data signals are transmitted through one or more paths.

### Hologram Beamforming

Beamforming is a signal processing procedure that adjusts an antenna array to transmit radio signals in a specific direction. This is a subset of smart antennas or advanced antenna systems. Beamforming technology has several advantages, such as high signal-to-noise ratio, interference prevention and rejection, and high network efficiency. Hologram Beamforming (HBF) is a new beamforming method that differs significantly from MIMO systems because this uses a software-defined antenna. HBF will be a very effective approach for efficient and flexible transmission and reception of signals in multi-antenna communication devices in 6G.

### Optical Wireless Technology

Optical wireless communication (OWC) is a form of optical communication that uses visible light, infrared light (IR), or ultraviolet light (UV) to carry signals. OWC operating in the visible light band (e.g., 390 to 750 nm) is commonly referred to as visible light communication (VLC). VLC implementations can utilize light-emitting diodes (LEDs). VLC can be used in a variety of applications, including wireless local area networks, wireless personal area networks, and vehicular networks.

VLC has several advantages over RF-based technologies. First, the spectrum occupied by VLC is free/unlicensed and can provide extensive bandwidth (THz-level bandwidth). Second, VLC rarely causes significant interference to other electromagnetic devices; therefore, VLC can be applied in sensitive electromagnetic interference applications such as aircraft and hospitals. Third, VLC has strengths in communication security and privacy. The transmission medium of VLC-based networks, namely visible light, cannot pass through walls and other opaque obstacles. Therefore, the transmission range of VLC can be limited to indoors, which can protect users' privacy and sensitive information. Fourth, VLC can use any light source as a base station, eliminating the need for expensive base stations.

Free-space optical communication (FSO) is an optical communication technology that uses light propagating in free space, such as air, outer space, and vacuum, to wirelessly transmit data for telecommunications or computer networking. FSO can be used as a point-to-point OWC system on the ground. FSO can operate in the near-infrared frequency (750-1600 nm). Laser transmitters may be used in FSO implementations, and FSO can provide high data rates (e.g., 10 Gbit/s), providing a potential solution to backhaul bottlenecks.

These OWC technologies are planned for 6G communications in addition to RF-based communications for all possible device-to-access networks. These networks will access network-to-backhaul/fronthaul network connections. OWC technology has already been in use since 4G communication systems, but will be more widely used to meet the needs of 6G communication systems. OWC technologies such as light fidelity, visible light communication, optical camera communication, and FSO communication based on optical bands are already well-known technologies. Communication based on optical wireless technology can provide extremely high data rates, low latency, and secure communication.

Light Detection And Ranging (LiDAR) is also based on the optical band and can be utilized in 6G communications for ultra-high resolution 3D mapping. LiDAR is a remote sensing method that uses near-infrared, visible, and ultraviolet light to illuminate an object, and the reflected light is detected by a light sensor to measure distance. LiDAR can be used for fully automated driving of cars.

### FSO Backhaul Network

The characteristics of the transmitter and receiver of the FSO system are similar to those of an optical fiber network. Accordingly, data transmission of the FSO system similar to that of the optical fiber system. Accordingly, FSO may be a good technology for providing backhaul connection in the 6G system along with the optical fiber network. When FSO is used, very long-distance communication is possible even at a distance of 10,000 km or more. FSO supports mass backhaul connections for remote and non-remote areas such as sea, space, underwater and isolated islands. FSO also supports cellular base station connections.

### Non-Terrestrial Networks (NTN)

The 6G system will integrate terrestrial and aerial networks to support vertically expanding user communications. 3D BS will be delivered via low-orbit satellites and UAVs. Adding a new dimension in terms of altitude and associated degrees of freedom makes 3D connectivity quite different from traditional 2D networks. NR considers Non-Terrestrial Networks (NTNs) as one way to accomplish this. An NTN is a network or network segment that uses RF resources aboard a satellite (or UAS platform). There are two common scenarios for NTNs that provide access to user equipment: transparent payloads and regenerative payloads. The following are the basic elements of an NTN.
One or more sat-gateways that connect the NTN to the public data network.
GEO satellites are fed by one or several satellite gateways deployed across the satellite target range (e.g., regional or continental coverage). We assume that the UEs in a cell are served by only one sat-gateway.
Non-GEO satellites that are continuously serviced by one or multiple satellite gateways at a time. The system ensures service and feeder link continuity between successively serviced satellite gateways with a time duration sufficient to allow for mobility anchoring and handover.
The feeder link or radio link between the satellite gateway and the satellite (or UAS platform).
The service link or radio link between the user equipment and the satellite (or UAS platform).
A satellite (or UAS platform) that can implement transparent or regenerative (with onboard processing) payloads. Satellite (or UAS platform) generated beams typically produce multiple beams for a given service area, depending on the field of view. The footprint of the beam is typically elliptical. The field of view of the satellite (or UAS platform) depends on the onboard antenna diagram and the minimum angle of attack.
Transparent payload: Radio frequency filtering, frequency conversion, and amplification, so the waveform signal repeated by the payload is unchanged.
Regenerative payload: radio frequency filtering, frequency conversion and amplification, demodulation/decryption, switching and/or routing, and coding/modulation. This is effectively the same as having all or part of the base station functions (e.g., gNB) on board a satellite (or UAS platform).
For satellite deployments, optionally an inter-satellite link (ISL). This requires a regenerative payload on the satellite. ISLs can operate at RF frequencies or in the optical band.
User equipment is served by satellites (or UAS platforms) within the targeted coverage area.

Typically, GEO satellites and UAS are used to provide continental, regional, or local services.

Typically, constellations in LEO and MEO are used to provide coverage in both the Northern and Southern Hemispheres. In some cases, constellations can also provide global coverage, including polar regions. The latter requires proper orbital inclination, sufficient beams generated, and links between satellites.

### Quantum Communication

Quantum communication is a next-generation communication technology that can overcome the limitations of conventional communication such as security and high-speed computation by applying quantum mechanical properties to the field of information and communication. Quantum communication provides a means of generating, transmitting, processing, and storing information that cannot be expressed in the form of Os and Is according to the binary bit information used in existing communication technologies. In conventional communication technologies, wavelengths or amplitudes are used to transmit information between the transmitting and receiving ends, but in quantum communication, photons, the smallest unit of light, are used to transmit information between the transmitting and receiving ends. In particular, in the case of quantum communication, quantum uncertainty and quantum irreversibility can be used for the polarization or phase difference of photons (light), so quantum communication has the characteristic of being able to communicate with perfect security. In addition, quantum communication can also enable ultra-high-speed communication using quantum entanglement under certain conditions.

### Cell-Free Communication

Tight integration of multiple frequencies and heterogeneous communication technologies is critical in 6G systems. As a result, users can seamlessly move from one network to another without having to create any manual configurations on their devices. The best network is automatically selected from the available communication technologies. This will break the limitations of the cell concept in wireless communication. Currently, user movement from one cell to other causes too many handovers in dense networks, resulting in handover failures, handover delays, data loss, and ping-pong effects. 6G cell-free communication will overcome all this and provide better QoS.

Cell-free communication is defined as “a system in which a large number of geographically distributed antennas (APs) cooperatively serve a small number of terminals using the same time/frequency resources with the help of a fronthaul network and a CPU”. A single terminal is served by a set of multiple APs, which is called an AP cluster. There are several ways to form AP clusters, among which the method of configuring AP clusters with APs that can significantly contribute to improving the reception performance of the terminal is called the terminal-centered clustering method, and when using this method, the configuration is dynamically updated as the terminal moves. By adopting this device-centric AP clustering technique, the device is always at the center of the AP cluster and is therefore free from inter-cluster interference that can occur when the device is located at the boundary of the AP cluster. This cell-free communication will be achieved through multi-connectivity and multi-tier hybrid technologies and different heterogeneous radios in the device.

### Integration of Wireless Information and Energy Transfer (WIET)

WIET uses the same field and wave as a wireless communication system. In particular, a sensor and a smartphone will be charged using wireless power transfer during communication. WIET is a promising technology for extending the life of battery charging wireless systems. Therefore, devices without batteries will be supported in 6G communication.

### Integration of Wireless Communication and Sensing

An autonomous wireless network is a function for continuously detecting a dynamically changing environment state and exchanging information between different nodes. In 6G, sensing will be tightly integrated with communication to support autonomous systems.

### Integrated Access and Backhaul Network

In 6G, the density of access networks will be enormous. Each access network is connected by optical fiber and backhaul connection such as FSO network. To cope with a very large number of access networks, there will be a tight integration between the access and backhaul networks.

### Big Data Analysis

Big data analysis is a complex process for analyzing various large data sets or big data. This process finds information such as hidden data, unknown correlations, and customer disposition to ensure complete data management. Big data is collected from various sources such as video, social networks, images and sensors. This technology is widely used for processing massive data in the 6G system.

### Reconfigurable Intelligent Surface

There is a large body of research that considers the radio environment as a variable to be optimized along with the transmitter and receiver. The radio environment created by this approach is referred to as a Smart Radio Environment (SRE) or Intelligent Radio Environment (IRE) to highlight its fundamental differences from past design and optimization criteria. Various terms have been proposed for the reconfigurable intelligent antenna (or intelligent reconfigurable antenna technology) technology that enables SRE, including Reconfigurable Metasurfaces, Smart Large Intelligent Surfaces (SLIS), Large Intelligent Surfaces (LIS), Reconfigurable Intelligent Surface (RIS), and Intelligent Reflecting Surface (IRS).

In the case of THz band signals, there are many shadowed areas caused by obstacles due to the strong straightness of the signal, and RIS technology is important to expand the communication area by installing RIS near these shadowed areas, strengthening communication stability and enabling additional value-added services. RIS is an artificial surface made of electromagnetic materials that can alter the propagation of incoming and outgoing radio waves. While RIS can be seen as an extension of massive MIMO, it has a different array structure and operating mechanism than massive MIMO. RIS also has the advantage of lower power consumption because it operates as a reconfigurable reflector with passive elements, meaning it only passively reflects the signal without using an active RF chain. In addition, each of the passive reflectors in the RIS must independently adjust the phase shift of the incident signal, which can be advantageous for wireless communication channels. By properly adjusting the phase shift through the RIS controller, the reflected signal can be gathered at the target receiver to boost the received signal power.

In addition to reflecting radio signals, there are also RISs that can adjust transmission and refraction properties, and these RISs are mainly used for O2I (Outdoor to Indoor). Recently, STAR-RIS (Simultaneous Transmission and Reflection RIS), which provides transmission while reflecting, has also been actively researched.

### Metaverse

Metaverse is a portmanteau of the words “meta” meaning virtual, transcendent, and “universe” meaning space. Generally speaking, the metaverse is a three-dimensional virtual space where the same social and economic activities as in the real world are commonplace.

Extended Reality (XR), a key technology enabling the Metaverse, is the fusion of the virtual and the real, which can extend the experience of reality and provide a unique sense of immersion. The high bandwidth and low latency of 6G networks will enable users to experience more immersive virtual reality (VR) and augmented reality (AR) experiences.

### Autonomous Driving, Self-driving

For perfect autonomous driving, vehicles must communicate with each other to inform each other of dangerous situations, or with infrastructure such as parking lots and traffic lights to check information such as the location of parking information and signal change times. Vehicle-to-Everything (V2X), a key element in building an autonomous driving infrastructure, is a technology that enables vehicles to communicate and share information with various elements on the road, such as vehicle-to-vehicle (V2V) and vehicle-to-infrastructure (V2I), for autonomous driving.

In order to maximize the performance of autonomous driving and ensure high safety, fast transmission speeds and low latency technologies are essential. In addition, in the future, autonomous driving will go beyond delivering warnings and guidance messages to the driver to actively intervene in vehicle operation and directly control the vehicle in dangerous situations, and the amount of information that needs to be transmitted and received will be enormous, so 6G is expected to maximize autonomous driving with faster transmission speeds and lower latency than 5G.

### Unmanned Aerial Vehicle (UAV)

An unmanned aerial vehicle (UAV) or drone will be an important factor in 6G wireless communication. In most cases, a high-speed data wireless connection is provided using UAV technology. A base station entity is installed in the UAV to provide cellular connectivity. UAVs have certain features, which are not found in fixed base station infrastructures, such as easy deployment, strong line-of-sight links, and mobility-controlled degrees of freedom. During emergencies such as natural disasters, the deployment of terrestrial telecommunications infrastructure is not economically feasible and sometimes services cannot be provided in volatile environments. The UAV can easily handle this situation. The UAV will be a new paradigm in the field of wireless communications. This technology facilitates the three basic requirements of wireless networks, such as eMBB, URLLC and mMTC. The UAV can also serve a number of purposes, such as network connectivity improvement, fire detection, disaster emergency services, security and surveillance, pollution monitoring, parking monitoring, and accident monitoring. Therefore, UAV technology is recognized as one of the most important technologies for 6G communication.

### Block-Chain

A blockchain will be important technology for managing large amounts of data in future communication systems. The blockchain is a form of distributed ledger technology, and distributed ledger is a database distributed across numerous nodes or computing devices. Each node duplicates and stores the same copy of the ledger. The blockchain is managed through a peer-to-peer (P2P) network. This may exist without being managed by a centralized institution or server. Blockchain data is collected together and organized into blocks. The blocks are connected to each other and protected using encryption. The blockchain completely complements large-scale IoT through improved interoperability, security, privacy, stability and scalability. Accordingly, the blockchain technology provides several functions such as interoperability between devices, high-capacity data traceability, autonomous interaction of different IoT systems, and large-scale connection stability of 6G communication systems.

### <Random Access Channel (RACH) Procedure>

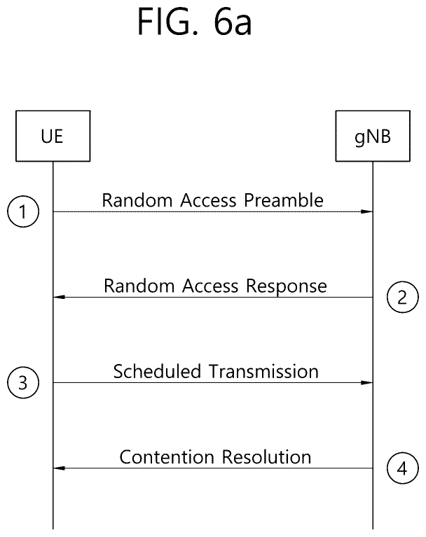

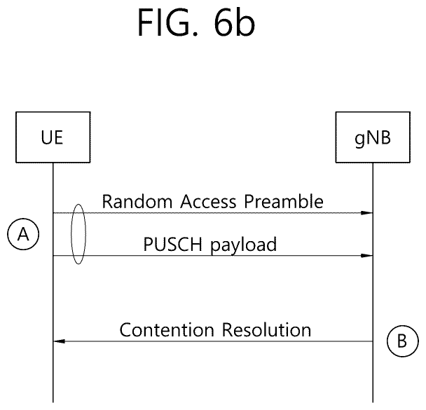

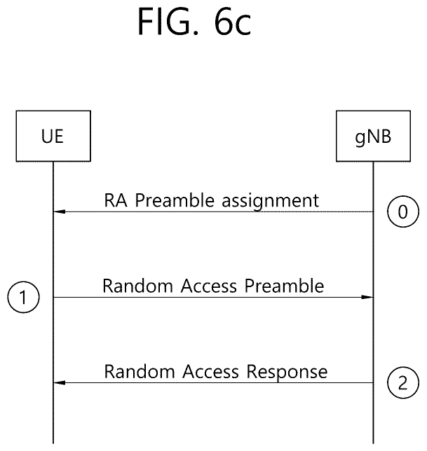

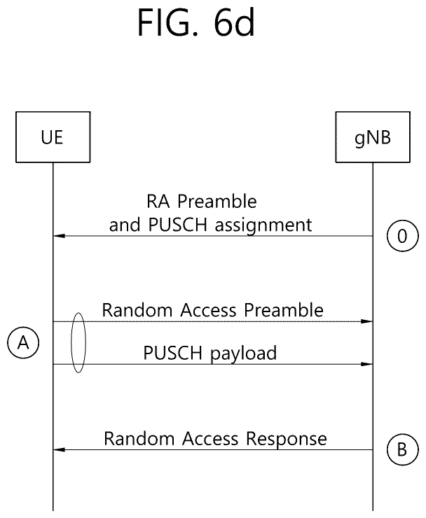

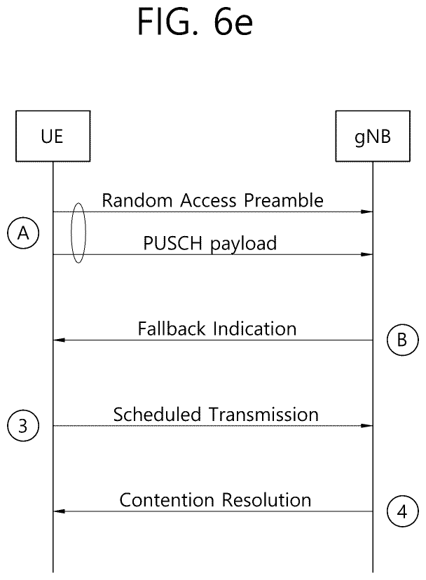

FIGS. 6a through 6e shows an example of RACH procedures applicable to an embodiment of the present disclosure.

Referring to FIGS. 6a through 6e, a RACH procedure is described, according to one embodiment of the present disclosure. The embodiments of FIGS. 6a through 6e may be combined with various embodiments of the present disclosure.

In one embodiment of the disclosure, where RF requirements (e.g., Tx RF performance requirements and/or Rx RF performance requirements) are described, the UE may satisfy those RF requirements. For example, a UE may be tested to satisfy RF requirements (e.g., Tx RF performance requirements and/or Rx Rf performance requirements) according to one embodiment of the disclosure. In one embodiment of the disclosure, a UE that meets these RF requirements may perform the RACH procedure. When the UE transmits messages, data, signaling, etc. to the gNB, the UE satisfies the Tx RF performance requirements described in the first embodiment of this specification. When the UE receives messages, data, signaling, etc. from the gNB, the UE satisfies the Rx RF performance requirements described in the first embodiment of this specification.

To connect the UE to the 5G network, the UE and the 5G network must synchronize in the uplink and downlink. Downlink synchronization is performed when the UE successfully decodes the SSB transmitted by the gNB. To establish the uplink synchronization and RRC connection, the UE shall perform the RACH random access procedure.

Two types of random access procedures are supported. The two types of random access procedures include a four-stage Random Access (RA) type using MSG1 and a two-stage RA type using MSGA.

The two types of RA procedures can support Contention Based Random Access (CBRA) and Contention Free Random Access (CFRA), as shown in FIG. 6a through FIG. 6e below, respectively. The UE may select the random access type at the beginning of the random access procedure, depending on the network configuration.

Referring to FIG. 6a and FIG. 6c, a four-stage RA type using MSG1 is illustrated.

Step 4 The MSG1 of RA type contains the preamble of the PRACH. The UE transmits the MSG1. After the UE sends the MSG1, the UE monitors the network for a response within the set window.

For CBRA according to the example of FIG. 6a, when the UE receives a random access response (MSG2) from the gNB, the UE may transmit MSG3 using the UL grant scheduled by the response message. The UE may then monitor the contention resolution. If contention resolution is not successful after the MSG3 (re)transmission, the UE shall perform the MSG1 transmission again.

For CFRA according to the example in FIG. 6c, a dedicated preamble for MSG1 transmission is allocated by the network. The gNB sends the RA preamble assignment to the UE. The UE transmits an MSG1 containing the random access preamble to the gNB. Upon receiving the random access response from the network, the UE terminates the random access procedure.

Referring to FIGS. 6b, 6d, and 6e, a two-stage RA type is described. The MSGA of the two-stage RA type includes a random access preamble on the PRACH and a PUSCH payload. After the UE transmits the MSGA, the UE monitors the response from the network within a set window.

For CBRA according to the example of FIG. 6b, after the UE receives the network response (e.g., MSGB), if the contention resolution is successful, the UE terminates the random access procedure. If the fallback indication is received within the MSGB, the UE performs the MSG3 transmission using the UL grant scheduled in the fallback indication and monitors the contention resolution, as shown in FIG. 6e. If contention resolution is not successful after the MSG3 (re)transmission, the UE shall perform the MSGA transmission again.

In the case of CFRA according to the example of FIG. 6d, the UE may receive RA preamble allocation and PUSCH allocation from the gNB. Dedicated preamble and PUSCH resources may then be set up for MSGA transmission. The UE transmits the MSGA. When the UE receives a network response, the UE terminates the random access procedure.

If the random access procedure of the two-stage RA type is not completed after several MSGA transmissions, the UE may be set to switch to the CBRA of the four-stage RA type.

### <The Present Disclosure of the Present Specification>

Performance requirements and test items for terminals and base stations per frequency band should be able to be supported.

For terminals using the ultra-high frequency band, radio performance specifications have been defined based on a single receive RF chain. The use of terminals supporting multiple RF chains is being discussed.

However, there is a problem that wireless performance specifications related to terminals supporting multiple RF chains have not been defined in the past. As a result, there is a need to define spherical coverage requirements for terminals that receive signals from multiple directions simultaneously.

In various examples of the disclosure, a wireless performance specification for a terminal supporting multiple RF chains in the ultra-high frequency band may be proposed. For example, spherical coverage requirement for simultaneous reception from multiple direction may be defined.

The present specification proposes a receiving RF specification and related matters for a terminal that simultaneously receives signals form multiple directions in FR2-1 (frequency range: 24250 MHz to 52600 MHz).

Currently, the 3GPP standard specification defines the frequency range as shown in Table 6 below.

TABLE 6

| | |
|---|---|
| Frequency range designation | Corresponding frequency range |

| FR1 | | 410 MHz-7125 MHz |
|---|---|---|
| FR2 | FR2-1 | 24250 MHz-52600 MHz |
| | FR2-2 | 52600 MHz-71000 MHz |

To date, RF reception specifications for FR2 terminals have been specified assuming that only a single RF panel is active at the same time. For referece, the terms terminal and UE are used interchangeably in the present disclosure.

RF reception specifications for terminals that can receive signals from two different directions at the same time will be discussed.

Based on the objective of an document [RP-221753] which is captured below, it is introduced that enhance RF requirements for PC3 with simultaneous reception from different directions with different Quasi Co Located (QCL) TypeD Reference Signals (RSS).

The following is the objective of the exemplary document.
Introduce necessary requirement(s) for enhanced FR2-1 UEs with simultaneous DL reception with two different QCL TypeD RSs on single component carrier with up to 4 layer DL MIMO:
Enhanced RF requirements:
Need to specify RF requirements, mainly spherical coverage requirements, for devices with simultaneous reception from different directions with different QCL TypeD RSs.
The legacy spherical coverage requirement for reception from a single direction may be kept.
Power class 3 (PC3) will be prioritized, other power classes should be considered after the PC3 requirements framework is finalized. In the present disclosure, UE may be a PC3 UE.
Introduce necessary requirement(s) for enhanced FR2-1 UEs with simultaneous DL reception from different directions with different QCL TypeD RSs on a single component carrier:
Enhanced RRM requirements may be defined:
The following requirements should be studied and specified if necessary:
L1-RSRP measurement delay
L3 measurement delay (both cell detection delay and measurement period can be considered). The starting point may be the enhancements related to L1-RSRP measurement enhancements.
RLM and BFD/CBD requirements
Scheduling/measurement restrictions
TCI state switching delay with dual TCI
Receive timing difference between different directions (different QCL Type D RSs)

NOTE: The case of single Transmission Configuration Indicator (TCI) is handled as a second priority. Additional aspects related to single TCI can be further revisited.

In Rel-17, FR2-1 UE can support up to 2 layer with 2 RX ports in single carrier. For the UE, Radio Frequency (RF) requirements such as reference receive sensitivity (REFSENS) (effective isotropic sensitivity: EIS) and EIS spherical coverage were specified with 1 layer and demodulation performance requirements were specified with up to 2 layer.

The following is the formula for REFSENS. Herein, diversity gain of 0 dB was assumed.

$$REFSENS = - 174 dBm ( kT ) + 10 * log 10 ( Max . RX BW ) + NF - Total Ant . gain - diversity gain + SNR + ILs$$

For PC3, EIS spherical coverage requirement was specified with EIS at Complementary Cumulative Distribution Function (CCDF) of 50%-tile considering the activated one panel at a time.

Baseline Assumption for RF requirement is explained.

In the present disclosure, compared to prior arts, main difference is that UE should support simultaneous reception from different directions with different QCL TypeD RSs up to 4 layers. The UE may transmit capability information indicating that the UE supports the simultaneous reception from different directions with different QCL TypeD RSs up to 4 layers. For example, the capability information may be simultaneousReceptionDiffTypeD.

And, multiple simultaneous transmission from different directions are also considered.

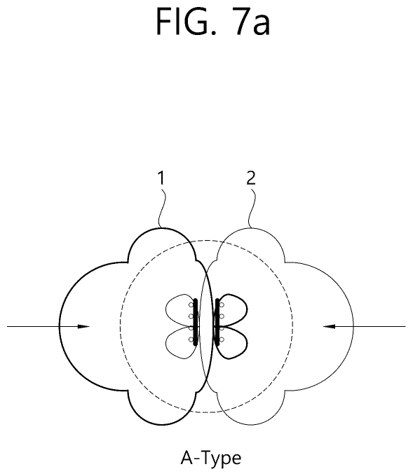

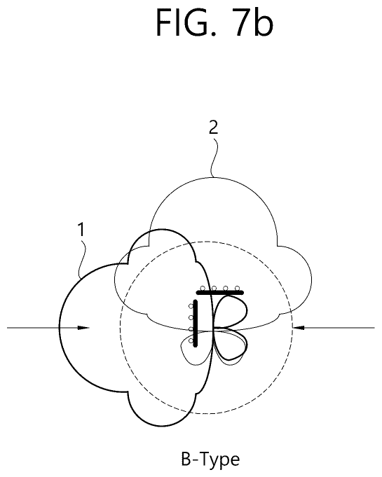

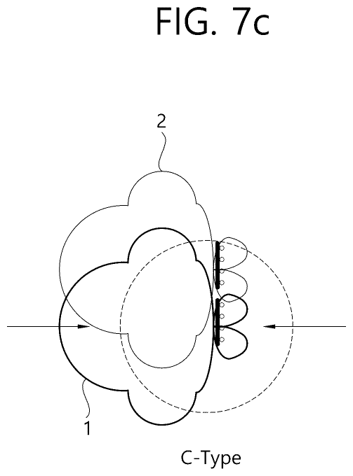

To support it, at least 2 panels may need to be activated simultaneously. FIGS. 7a to 7c shows the possible example of 2 panel placements.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

FIGS. 7a to 7c illustrate examples of possible example of 2 panel placements according to an embodiment of the present disclosure.

For example, FIG. 7a shows an example of Back to Back(a), FIG. 7b shows an example of Orthogonal(b), FIG. 7c shows an example of In line(c). Herein, the opposite direction may be assumed.

From FIGS. 7a to 7c, Back to Back placement of FIG. 7a may be more applicable for the opposite direction. For RF requirements, panel placements may be considered. Back to Back(a) of FIG. 7a may be named with ‘A-type’ and Orthogonal(b) of FIG. 7b may be named with ‘B-type’.

For how to define RF requirements, antenna gain of all directions for both A-type and B-type at frequency of 28 GHz is used for a simulation. Simulation Assumption is as follows.

### —Simulation Assumption:

Frequency: 28 GHz
2 Panel Distance: 7 cm
Phase Step: 45° (8 Beam)

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

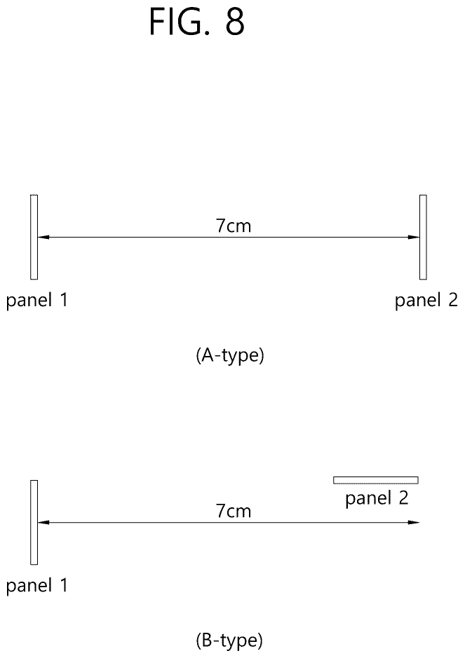

FIG. 8 illustrates examples of 2 panel placements according to an embodiment of the present disclosure.

FIG. 8 shows 2 panel placements including A-type and B-type based on the simulation assumption.

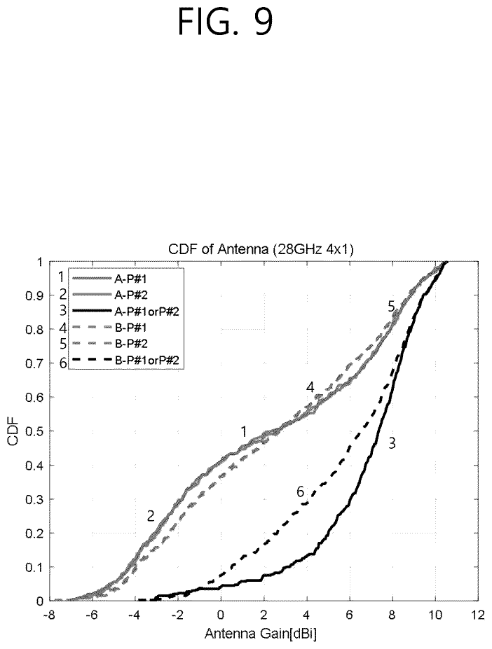

For A-type and B-type, if only one panel is activated, the CDF (cumulative distribution function) of antenna beam gain is seen as FIG. 9.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

FIG. 9 illustrates examples of CDF of antenna beam gain for the activated one panel according to an embodiment of the present disclosure.

The cases that only one panel is activated may include:
1a. Only panel #1 is activated in A-type
1b. Only panel #2 is activated in A-type
1c. Either panel #1 or panel #2 is activated in A-type
2a. Only panel #1 is activated in B-type
2b. Only panel #2 is activated in B-type
2c. Either panel #1 or panel #2 is activated in B-type

From FIG. 9, antenna beam gain at CDF of 50% is that,
1c is higher than 1a and 1b for A-type
2c is higher than 2a and 2b for B-type
1c for A-type is higher than 2c for B-type

For simultaneous reception from different directions, 2 panels (panel #1 and panel #2 in FIG. 8) are assumed to be activated simultaneously, and 2 panels are assumed to receive each direction.

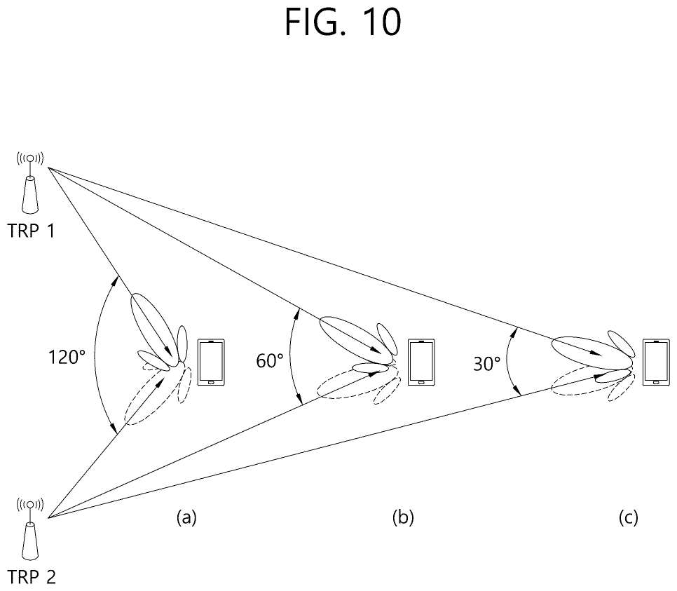

FIG. 10 shows the AoA (Angle of Arrival) of simultaneous 2 Rx directions. It depends on distance from UE to 2 Transmission Reception Points (TRPs).

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

FIG. 10 illustrates examples of AoA of simultaneous 2 different Rx directions according to an embodiment of the present disclosure.

In FIG. 10, (a), (b) and (c) show Angle-of-Arrival (AoA)=120°, 60° and 30° respectively.

In general, the AoA can be from 0° to 180°. However, considering all possible AoAs for RF requirements is not recommended because huge test time is required. To reduce test time, AoA of 30°, 60°, 90°, 120°, 150° need to be considered for RF requirements.

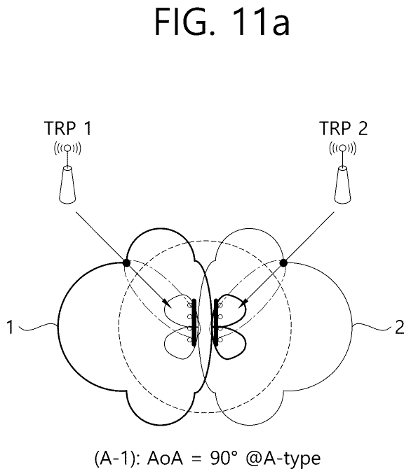

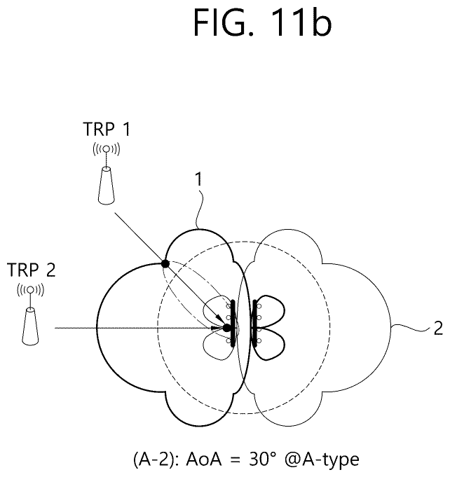

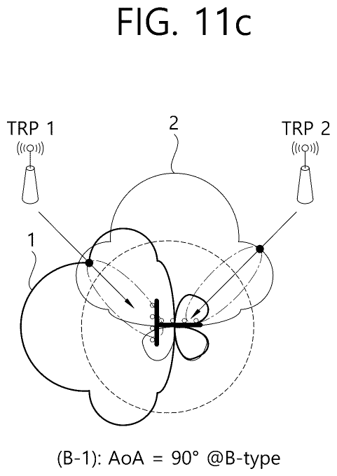

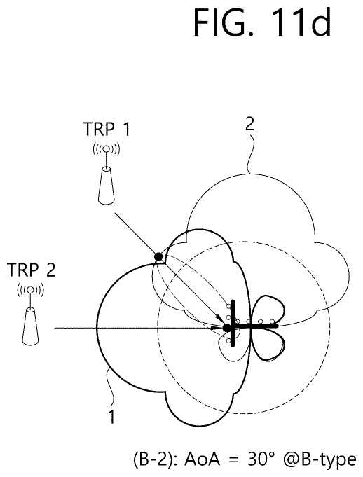

FIGS. 11a to 11d show examples for Rx Beam antenna gain of AoA 30° and 90° for A-type and B-type.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

FIGS. 11a to 11d illustrate examples of Rx Beam gain of AoA pair for simultaneous 2 different Rx directions according to an embodiment of the present disclosure.

It is assumed that UE receives TRP1 with panel #1 (antenna beam gain marked with 1) and TRP2 with panel #2 (antenna beam gain marked with 2). The dashed circle is assumed to be the antenna beam gain to meet spherical coverage of 50%. So, the region which the antenna beam gain on the left is higher than the dashed circle may correspond to the spherical coverage of 50%.

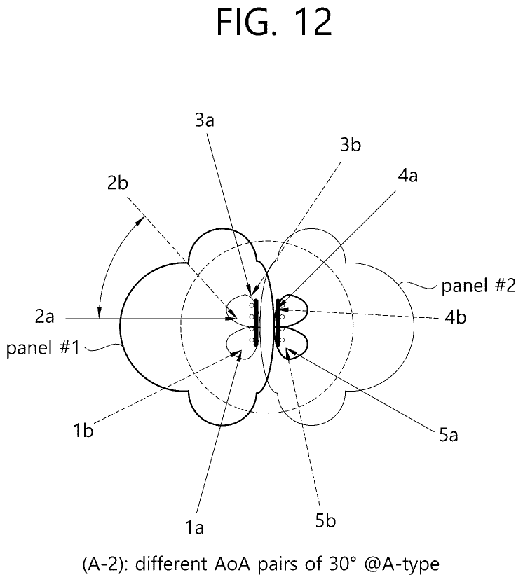

FIG. 12 shows the different AoA pairs for AoA=30° at A-type.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

FIG. 12 illustrates examples of different AoA pairs according to an embodiment of the present disclosure.

FIG. 12 shows AoA pairs of 30° with A-type

In FIG. 12, 5 AoA pairs ({1a,1b}, {2a, 2b}, {3a, 3b}, {4a, 4b}, {5a, 5b}) may be considered as example. In the pairs, {1a, 2a, 3a, 4a and 5a} correspond to the reception from panel #1 and {1b, 2b, 3b, 4b and 5b} correspond to the reception from panel #2. The reception from {1a, 2a, 3a} is to meet the spherical coverage of 50% of panel #1 and the reception from {4a, 5a} is not to meet the spherical coverage of 50% of panel #1. Here, {2a} is assumed to peak direction of panel #1.

{1a, 2a, 3a}: region to meet spherical coverage of 50% of panel #1

{4a, 5a}: region not to meet spherical coverage of 50% of panel #1 (lower spherical coverage)

{2a}: peak direction of panel #1

In AoA pair of {3a, 3b}, the Rx power difference between {3a} and {3b} from each panel is almost same. However, in AoA pair of {1a, 1b} and {2a, 2b}, the Rx power difference is very high. For explanation, we named it as ‘Rx power imbalance (RxPwrImb)’. If Rx power imbalance is hither than ‘threshold’, it is not considered as the AoA pair.

Method of calculating CDF may be explained.

To define UE RF requirements for simultaneous reception of 2 directions, 6 cases may be analyzed for AoA pair of 30°, 60°, 90°, 120°, 150° considering Rx power imbalance as follows.

Case 5: Only verify the UE functionality (e.g., go or no-go) under two AoAs with a fixed DL power level. If min [SINR_AoA1, SINR_AoA2]>=−1 dB, PASS, otherwise, FAIL. The requirements can be defined by averaging the Pass ratios of 3 UE oriented axes.

Case 6: Only verify the UE functionality (e.g., go or no-go) under two AoAs with a fixed DL power level. If min [SINR_AoA1, SINR_AoA2]>=−1 dB, PASS, otherwise, FAIL. The requirements can be defined by averaging the Pass ratios of 3 UE oriented axes. Simulation based on case 5 is updated by simulation based on case 6.

In the present disclosure, one or more of the cases 5 to 6 may be applied in a combination. Spherical coverage requirement for simultaneous reception form multiple directions may be defined based on one or more of the cases 5 to 6. For example, 2AoA spherical coverage of power class 3 may be defined.

Based on the agreement in R4-2303708, the simulation for the ratio of qualified test points over the whole sphere may be performed.

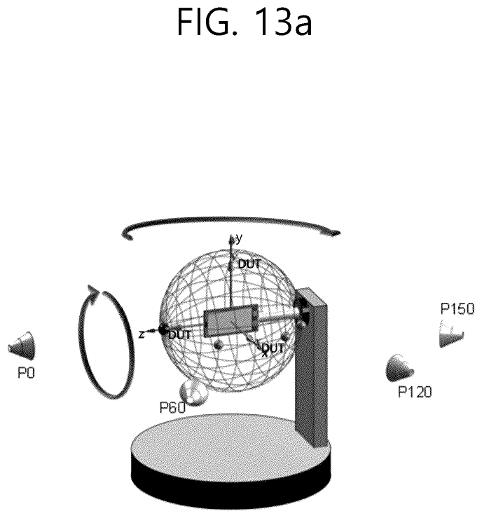

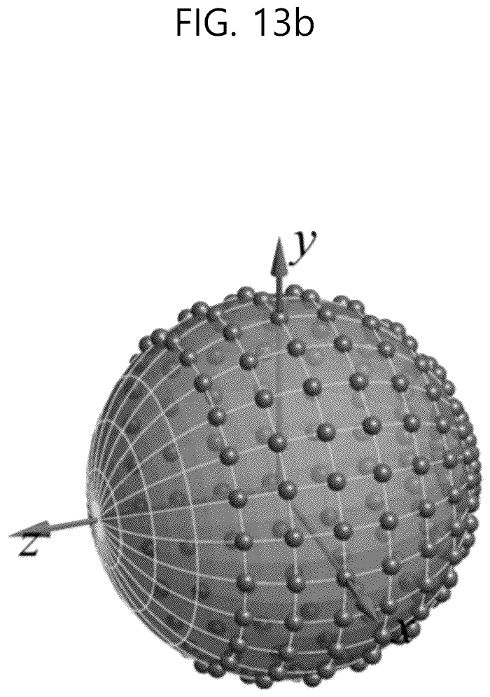

FIGS. 13a and 13b shows the test points and rotation method for 2 AOAs (REF: R4-2302522).

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

FIGS. 13a and 13b illustrate examples of test points and rotation method for 2AoAs according to an embodiment of the present disclosure.

For example, FIG. 13a shows how the UE is tested based on being rotating with respect to the z axis, the x axis, and/or the y axis. P0 may mean a direction having degree of 0 from z axis in zx plane. P60 may mean a direction having degree of 60 from z axis in zx plane. P120 may mean a direction having degree of 120 from z axis in zx plane. P150 may mean a direction having degree of 150 from z axis in zx plane. DUT may mean device under test.

FIG. 13b shows examples of downlink (DL) directions perceived by DUT from Probe P60 with Constant-step size grid.

3D Scan based on FIGS. 13a and 13b is performed based on full rotation Φ, which is based on z axis, and half rotation in θ based on y axis which is vertical to the ground.

In FIGS. 7a to 7c, A-type panel placement corresponds to antenna module combination of left-side and right-side, and B-type panel placement corresponds to antenna module combination of left-side and top-side in R4-2303708.

Case 5: Only verify the UE functionality (e.g., go or no-go) under two AoAs with a fixed DL power level. If min [SINR_AoA1, SINR_AoA2]>=−1 dB, PASS, otherwise, FAIL. The requirements can be defined by averaging the Pass ratios of 3 UE oriented axes.

RF requirements based on case 5 may be explained.

The simulation of pass ratio over the whole sphere is performed by considering different antenna module performances, different UE orientations, and different antenna module combinations.

Antenna module performance is based on:
Case 1: antenna module #1 and antenna module #2 are assumed to have the same performance gain
Case 2: antenna module #1 is assumed to have 3 dB lower performance gain than antenna module #2
Case 3: antenna module #2 is assumed to have 3 dB lower performance gain than antenna module #1
UE orientation
Z-axis oriented
Y-axis oriented
X-axis oriented. Probes are located in the xz plane in FIG. 13a.
Antenna module combination
left-side & right-side combination
left-side & top-side combination

Following assumptions are considered for case 5.

### Considered Simulation Assumption

# of antenna module=2, dual polarized.

array of element antenna in each antenna module=4×1.

UE assigns ‘first’ module to track TRP that yields highest RSRP among all combinations of modules and TRPs. The best of the other modules is assigned to track the other TRP

Pass/Fail criterion is based on that if min [SINR_AoA1, SINR_AoA2]>=−1 dB, PASS, otherwise, FAIL.

For a specific angular separation between 2 TRPs and a specific UE orientation under standardized DL power level which is equal between 2 TRPs, the result at each test point is constructed based on two AoA pairs containing that test point, i.e., AoA+ pair and AoA− pair. Overall result (probability to support 2TRP DL) is by averaging regional results.

Area weight type for spatial average (for constant-step grid). sin θ is used for summing or averaging data collected on a lat-long grid.

Both DL powers are same as the legacy spherical coverage EIS requirement as starting point

Scale the antenna gain to make UE align with both the legacy peak EIS and spherical coverage requirements

$$Noise ( dBm ) = - 174 + 10 * log 10 ( C B W ) + NF :$$

$$CBW = 100 MHz$$

$$NF = 10$$

### AOA Offsets:

30°, 60°, 90°, 120°, 150°, 180°

$$Band = n 257$$

Considered simulation procedure is based on the following:
1. For one UE implementation
2. For one UE orientation
3. Run EM simulation to obtain per-beam antenna gain patterns:
Constant step size is suggested <=5°
Performance difference between V/H element can be considered
Normalize antenna gain to align with the gain drop between peak EIS and spherical coverage in current spec
4. For one angular separation
5. For one test grid point in 3D scan. Select beam based on RSRP
5.1 Calculate SINR of AoA+ and AoA− respectively.

$$SINR = P\_signal / ( Noise + P\_interf )$$

Where the P_signal is the power of wanted signal and the P_interf is the power of interference, Noise (dBm)=−174+10*log 10 (CBW) +NF, CBW is channel bandwidth, NF=10

If SINR>=−1, PASS, otherwise, FAIL
5.3a OR combining the results of AoA+ and AoA−
5.3b No logic combination of the results of AoA+ and AoA−, but treat them as two separate points
(e.g., arithmetic mean)

Other methods for +/− offset data are not precluded

Companies are encouraging to provide analysis on the pros and cons for each “combination” method
5.4 Add weighting (sin θ or Clenshaw-Curtis Quadrature)
6. Repeat for other test grid point
7. Calculate the spherical coverage percentage
8. Repeat for other angular separation
9. Repeat for other UE orientations
10. Repeat for other UE implementations

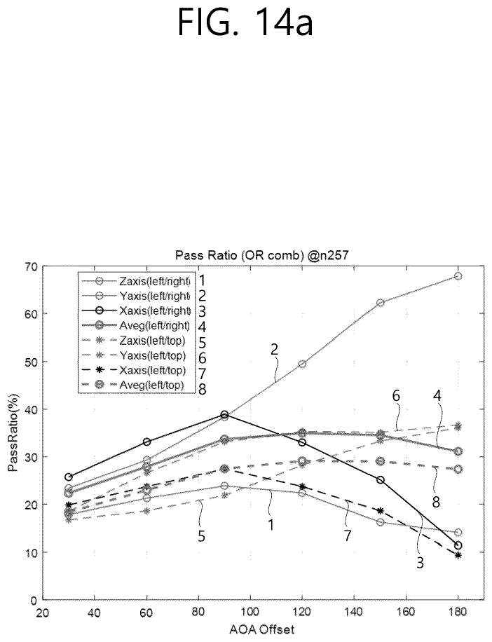

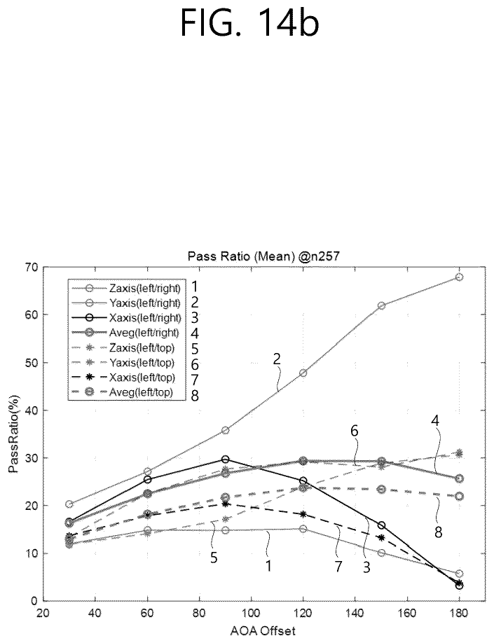

FIGS. 14a and 14b, FIGS. 15a and 15b, and FIGS. 16a and 16b show the results of the pass ratio of both OR combining and averaging for Case1, Case2, and Case3, respectively.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

FIGS. 14a and 14b illustrate examples of Pass Ratio of both ‘OR combining’ and ‘averaging’ for Case 1 according to an embodiment of the present disclosure.

FIG. 14a shows pass ratio based on OR combining for Case 1 of Case 5. FIG. 14b shows pass ratio based on Averaging for Case 1 of Case 5.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

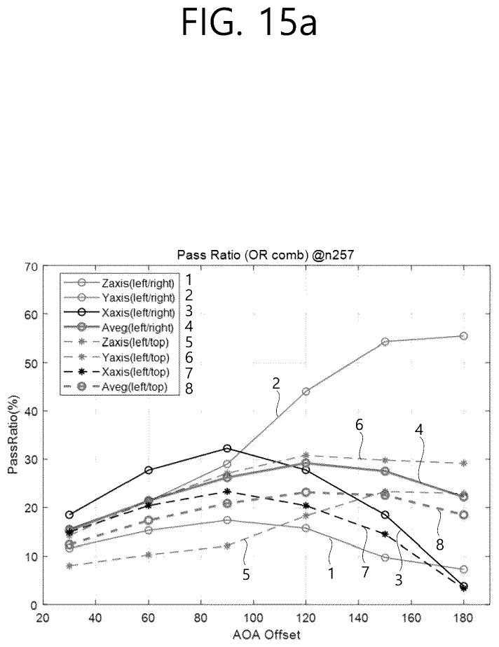

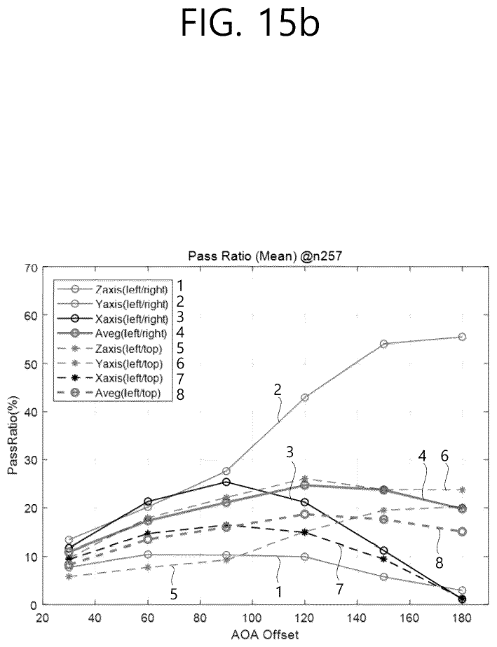

FIGS. 15a and 15b illustrate examples of Pass Ratio of both ‘OR combining’ and ‘averaging’ for Case 2 according to an embodiment of the present disclosure.

FIG. 15a shows pass ratio based on OR combining for Case 2 of Case 5. FIG. 15b shows pass ratio based on Averaging for Case 2 of Case 5.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

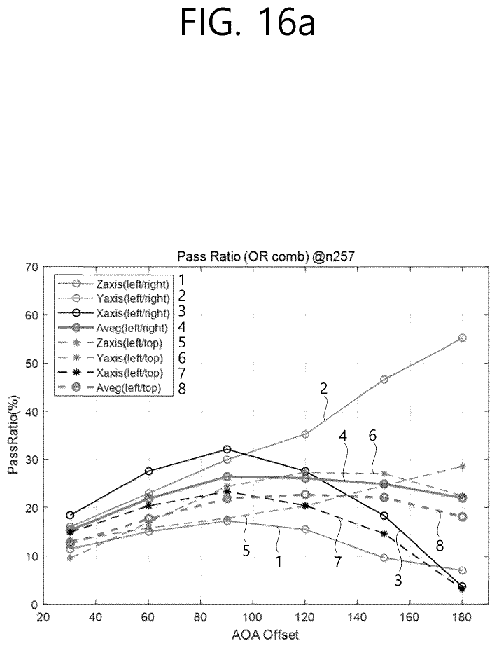

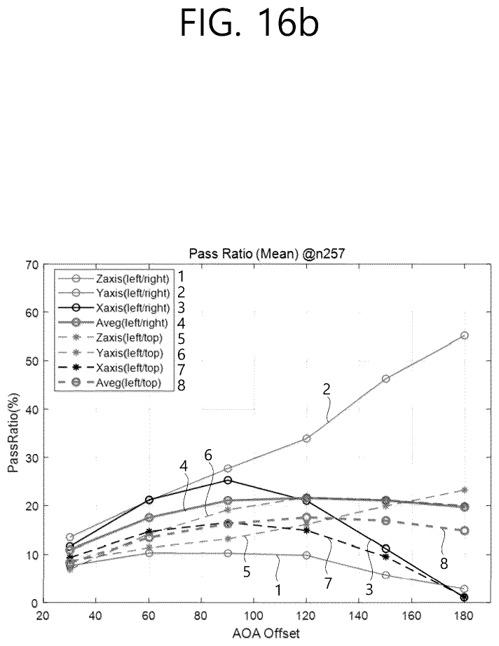

FIGS. 16a and 16b illustrate examples of Pass Ratio of both ‘OR combining’ and ‘averaging’ for Case 3 according to an embodiment of the present disclosure.

FIG. 16a shows pass ratio based on OR combining for Case 3 of Case 5. FIG. 16b shows pass ratio based on Averaging for Case 3 of Case 5.

In FIGS. 14a to 16b, 1 shows pass ratio based on Zaxis(left/right), 2 shows pass ratio based on Yaxis(left/right), 3 shows pass ratio based on Xaxis(left/right), 4 shows pass ratio based on Average value (Aveg)(left/right). 5 shows pass ratio based on Zaxis(left/top), 6 shows pass ratio based on Yaxis(left/top), 7 shows pass ratio based on Xaxis(left/top), 8 shows pass ratio based on Average value (Aveg)(left/top).

From the FIGS. 14a and 14b, FIGS. 15a and 15b, and FIGS. 16a and 16b, the followings are observed.

Observation 5-1: The variance of Pass ratio among UE oriented axes for both ‘OR combining’ and ‘averaging’ is high when AOA offset is high.

Observation 5-2: The variance of Pass ratio among UE oriented axes for antenna module combination of left&right is higher than that for antenna module combination of left&top when AOA offset is high.

Table 7 and Table 8 show the summary of the averaged Pass ratio among UE oriented axes for ‘OR combining’ and ‘averaging’ respectively.

TABLE 7

| | OR combining (%) | | | | | |
|---|---|---|---|---|---|---|
| | left & right-side | | | left & top-side | | |
| AoA Offset | Ant.moduleGain | | | Ant.moduleGain | | |
| (Degree) | Case 1 | Case 2 | Case 3 | Case 1 | Case 2 | Case 3 |
| 30 | 22.3 | 15.2 | 15.2 | 18.3 | 12.4 | 12.5 |
| 60 | 27.9 | 21.4 | 21.8 | 23.0 | 17.3 | 17.7 |
| 90 | 33.7 | 26.2 | 26.4 | 27.4 | 20.8 | 21.8 |
| 120 | 34.9 | 29.2 | 26.1 | 29.1 | 23.2 | 22.7 |
| 150 | 34.5 | 27.5 | 24.9 | 29.0 | 22.5 | 22.1 |
| 180 | 31.1 | 22.2 | 22.0 | 27.4 | 18.5 | 18.1 |

Table 7 shows Summary of the averaged Pass ratio among UE oriented axes for ‘OR combining’

TABLE 8

| | Averaging (%) | | | | | |
|---|---|---|---|---|---|---|
| | left & right-side | | | left & top-side | | |
| AoA Offset | Ant.moduleGain | | | Ant.moduleGain | | |
| (Degree) | Case 1 | Case 2 | Case 3 | Case 1 | Case 2 | Case 3 |
| 30 | 16.3 | 10.9 | 10.9 | 12.9 | 8.3 | 8.3 |
| 60 | 22.5 | 17.3 | 17.5 | 18.2 | 13.5 | 13.4 |
| 90 | 26.7 | 21.1 | 21.1 | 21.7 | 16.0 | 16.3 |
| 120 | 29.4 | 24.7 | 21.6 | 23.7 | 18.7 | 17.6 |
| 150 | 29.3 | 23.7 | 21.1 | 23.4 | 17.6 | 16.9 |
| 180 | 25.6 | 19.8 | 19.7 | 21.9 | 15.1 | 14.8 |

Table 8 shows Summary of the averaged Pass ratio among UE oriented axes for ‘averaging’.

Based on the tables 7 and 8, the followings are observed.

Observation 5-3: For the averaged Pass ratio among UE oriented axes for both ‘OR combining’ and ‘averaging’, the antenna module combination of ‘left&right’ is up to about 6% higher than ‘left&top’.

Observation 5-4: For the averaged Pass ratio among UE oriented axes for ‘OR combining’, Case1 is up to about 9% higher than Case 2, and 9.5% higher than Case 3 in Case 5.

Observation 5-5: For the averaged Pass ratio among UE oriented axes for ‘averaging’, Case1 is up to about 7% higher than Case 2, and 8.2% higher than Case 3 in Case 5.

To reduce the high variance of Pass Ratio depending on UE oriented axis, the requirement needs to be specified by averaging the Pass ratios of 3 UE oriented axes.

Proposal 5-1: Define the requirement by averaging the Pass ratios of 3 UE oriented axes.

Considering observation 5-3, the requirement needs to be defined by considering the lower Pass Ratio between antenna module combinations. For example, the antenna module combination of ‘left&top’ can be applied.

Proposal 5-2: Define the requirement by considering worst Pass Ratio between antenna module combinations.

Considering observation 5-4 and observation 5-5, if a single requirement is defined regardless of whether one antenna module has a lower antenna performance gain than another antenna module, the requirement can be too relaxed. Therefore, the different requirements need to be defined depending on the antenna modules' performance which can be indicated by UE capability. And, regarding that ‘averaging’ is lower difference than ‘OR combining’ between Case1 and Case2, or, Case1 and Case 3, ‘averaging’ is a bit preferable. Herein, Cases 1 to 3 are cases included in Case 5.

Proposal 5-3: Define the requirement with either ‘OR combining’ or ‘averaging’.

Proposal 5-4: How to specify the difference of Pass Ratio according to antenna modules' performance should be considered.

Proposal 5-5: Introduce UE capability if the different requirements are specified according to antenna modules' performance.

Proposal 5-5a: Consider UE capability on whether UE meets the normal requirement or the relaxed requirement. One example requirement can be Pass Ratio requirement. The normal requirement and the relaxed requirement are needed to be specified.

Proposal 5-5b: Consider UE capability on whether UE meets the relaxed requirement. One example requirement can be Pass Ratio requirement. If the UE capability is not indicated, the normal requirement may be applied. The normal requirement and the relaxed requirement may be needed to be specified.

Proposal 5-5c: Consider UE capability on whether UE meets the normal requirement. One example requirement can be Pass Ratio requirement. If the UE capability is not indicated, the relaxed requirement may be applied. The normal requirement and the relaxed requirement may be needed to be specified.

Proposal 5-5d: If no UE capability is defined, UE should meet a single requirement. One example requirement can be Pass Ratio requirement. The relaxed requirement is needed to be specified as the single requirement.

To guarantee that the averaged Pass Ratio is not high between AOA offsets, UE needs to meet the requirement of at least two AOA offsets. One is selected from {30°, 60°, 90°} and another is selected from {120°, 150°, 180°}.

Proposal 5-6: UE shall meet the requirement of at least two AOA offsets to reduce test time. One is selected from {30°, 60°, 90°} and another is selected from {120°, 150°, 180°}.

Table 9 can be one example of the FR2-1 PC3 requirement of Pass Ratio with ‘OR combining’ for both antenna modules are same antenna gain as the legacy antenna module.

Table 10 can be one example of the FR2-1 PC3 requirement of Pass Ratio with ‘OR combining’ for either antenna module is lower antenna gain than the legacy antenna module.

Table 11 can be one example of the FR2-1 PC3 requirement of Pass Ratio with ‘averaging’ for both antenna modules are same antenna gain as the legacy antenna module.

Table 12 can be one example of the FR2-1 PC3 requirement of Pass Ratio with ‘averaging” for either antenna module is lower antenna gain than the legacy antenna module.

Proposal 5-7: Define the requirements of Table 9 and Table 10 for ‘OR combining’, and Table 11 and Table 12 for ‘averaging’.

Proposal 5-7a: Consider Table 9 and Table 10 as one example of requirements for ‘OR combining’, and Table 11 and Table 12 as one example of requirements for ‘averaging’.

Proposal 5-8: Define the fixed DL power as the existing spherical coverage EIS.

Proposal 5-8a: Consider the existing spherical coverage EIS as the fixed DL power for Pass Ratio requirement.

In the proposal 5-7, for ‘OR combining’,

if UE indicates the capability on whether either antenna module is lower antenna gain (performance) than legacy antenna module, the requirement of Table 10 is applied as one example. If UE indicates the capability on whether both antenna modules are same antenna gain (performance) as legacy antenna module, or no indication, the requirement of Table 9 is applied as one example.

If a single requirement is applied regardless of that either antenna module is lower antenna gain than legacy antenna module, Table 10 can be applied as one example of requirement.

In the proposal 5-7, for ‘averaging’,

if UE indicates the capability on whether either antenna module is lower antenna gain (performance) than legacy antenna module, the requirement of Table 12 is applied as one example. If UE indicates the capability on whether both antenna modules are same antenna gain (performance) as legacy antenna module, or no indication, the requirement of Table 11 is applied as one example.

If a single requirement is applied regardless of that either antenna module is lower antenna gain than legacy antenna module, Table 12 can be applied as one example of requirement.

TABLE 9

| | Fixed DL power (dBm)/Channel bandwidth | | | | | | | | | |
|---|---|---|---|---|---|---|---|---|---|---|
| Operating | 50 | 100 | 200 | 400 | Pass Ratio(Y)[%]/AOA Offset (degree) | | | | | |
| band | MHz | MHz | MHz | MHz | 30° | 60° | 90° | 120° | 150° | 180° |
| n257 | −77.4 | −74.4 | −71.4 | −68.4 | 18 | 23 | 27 | 29 | 29 | 27 |
| n258 | −77.4 | −74.4 | −71.4 | −68.4 | 18 | 23 | 27 | 29 | 29 | 27 |
| n259 | −71.9 | −68.9 | −65.9 | −62.9 | TBD | TBD | TBD | TBD | TBD | TBD |
| n260 | −73.1 | −70.1 | −67.1 | −64.1 | TBD | TBD | TBD | TBD | TBD | TBD |
| n261 | −77.4 | −74.4 | −71.4 | −68.4 | 18 | 23 | 27 | 29 | 29 | 27 |
| n262 | −69.7 | −66.7 | −63.7 | −60.7 | TBD | TBD | TBD | TBD | TBD | TBD |

NOTE 1:
The transmitter shall be set to P_{UMAX} as defined in clause 6.2.4 of TS 38.101-2 V18.0.0
NOTE 2:
The EIS spherical coverage requirements of 2 AOA offsets are verified only under normal thermal conditions as defined in Annex E.2.1 of TS 38.101-2 V18.0.0.
NOTE 3:
UE shall meet at least two AOA offsets. One is from {30°, 60°, 90°} and another is from {120°, 150°, 180°}.

Herein, TBD means to be determined.

Table 9 shows Pass Ratio for ‘OR combining’ (Case1 in Case 5)

TABLE 10

| | Fixed DL power (dBm)/Channel bandwidth | | | | | | | | | |
|---|---|---|---|---|---|---|---|---|---|---|
| Operating | 50 | 100 | 200 | 400 | Pass Ratio(Y)[%]/AOA Offset (degree) | | | | | |
| band | MHz | MHz | MHz | MHz | 30° | 60° | 90° | 120° | 150° | 180° |
| n257 | −77.4 | −74.4 | −71.4 | −68.4 | 12 | 17 | 20 | 23 | 22 | 18 |
| n258 | −77.4 | −74.4 | −71.4 | −68.4 | 12 | 17 | 20 | 23 | 22 | 18 |
| n259 | −71.9 | −68.9 | −65.9 | −62.9 | TBD | TBD | TBD | TBD | TBD | TBD |
| n260 | −73.1 | −70.1 | −67.1 | −64.1 | TBD | TBD | TBD | TBD | TBD | TBD |
| n261 | −77.4 | −74.4 | −71.4 | −68.4 | 12 | 17 | 20 | 23 | 22 | 18 |
| n262 | −69.7 | −66.7 | −63.7 | −60.7 | TBD | TBD | TBD | TBD | TBD | TBD |

NOTE 1:
The transmitter shall be set to P_{UMAX} as defined in clause 6.2.4 of TS 38.101-2 V18.0.0.
NOTE 2:
The EIS spherical coverage requirements of 2 AOA offsets are verified only under normal thermal conditions as defined in Annex E.2.1 of TS 38.101-2 V18.0.0..
NOTE 3: UE shall meet at least two AOA offsets. One is from {30°, 60°, 90°} and another is from {120°, 150°, 180°}.

Table 10 shows Pass Ratio for ‘OR combining’ (Case2/Case3 in Case 5).

TABLE 11

| | Fixed DL power (dBm)/Channel bandwidth | | | | | | | | | |
|---|---|---|---|---|---|---|---|---|---|---|
| Operating | 50 | 100 | 200 | 400 | Pass Ratio(Y)[%]/AOA Offset (degree) | | | | | |
| band | MHz | MHz | MHz | MHz | 30° | 60° | 90° | 120° | 150° | 180° |
| n257 | −77.4 | −74.4 | −71.4 | −68.4 | 12 | 18 | 21 | 23 | 23 | 21 |
| n258 | −77.4 | −74.4 | −71.4 | −68.4 | 12 | 18 | 21 | 23 | 23 | 21 |
| n259 | −71.9 | −68.9 | −65.9 | −62.9 | TBD | TBD | TBD | TBD | TBD | TBD |
| n260 | −73.1 | −70.1 | −67.1 | −64.1 | TBD | TBD | TBD | TBD | TBD | TBD |
| n261 | −77.4 | −74.4 | −71.4 | −68.4 | 12 | 18 | 21 | 23 | 23 | 21 |
| n262 | −69.7 | −66.7 | −63.7 | −60.7 | TBD | TBD | TBD | TBD | TBD | TBD |

NOTE 1:
The transmitter shall be set to P_{UMAX} as defined in clause 6.2.4 of TS 38.101-2 V18.0.0.
NOTE 2:
The EIS spherical coverage requirements of 2 AOA offsets are verified only under normal thermal conditions as defined in Annex E.2.1 of TS 38.101-2 V18.0.0.
NOTE 3:
UE shall meet at least two AOA offsets. One is from {30°, 60°, 90°} and another is from {120°, 150°, 180°}.

Table 11 shows Pass Ratio for ‘averaging’ (Case1 in case 5).

TABLE 12

| | Fixed DL power (dBm)/Channel bandwidth | | | | | | | | | |
|---|---|---|---|---|---|---|---|---|---|---|
| Operating | 50 | 100 | 200 | 400 | Pass Ratio(Y)[%]/AOA Offset (degree) | | | | | |
| band | MHz | MHz | MHz | MHz | 30° | 60° | 90° | 120° | 150° | 180° |
| n257 | −77.4 | −74.4 | −71.4 | −68.4 | 8 | 13 | 16 | 18 | 17 | 15 |
| n258 | −77.4 | −74.4 | −71.4 | −68.4 | 8 | 13 | 16 | 18 | 17 | 15 |
| n259 | −71.9 | −68.9 | −65.9 | −62.9 | TBD | TBD | TBD | TBD | TBD | TBD |
| n260 | −73.1 | −70.1 | −67.1 | −64.1 | TBD | TBD | TBD | TBD | TBD | TBD |
| n261 | −77.4 | −74.4 | −71.4 | −68.4 | 8 | 13 | 16 | 18 | 17 | 15 |
| n262 | −69.7 | −66.7 | −63.7 | −60.7 | TBD | TBD | TBD | TBD | TBD | TBD |

NOTE 1:
The transmitter shall be set to P_{UMAX} as defined in clause 6.2.4 of TS 38.101-2 V18.0.0.
NOTE 2:
The EIS spherical coverage requirements of 2 AOA offsets are verified only under normal thermal conditions as defined in Annex E.2.1 of TS 38.101-2 V18.0.0.
NOTE 3:
UE shall meet at least two AOA offsets. One is from {30°, 60°, 90°} and another is from {120°, 150°, 180°}.

Table 12 shows Pass Ratio for ‘averaging’ (Case2/Case3).

In above Table 9, Table 10, Table 11 and Table 12, additional margin of ‘Δ 3’ can be considered on top of the value Y. For example, Δ 3 can be added to one or more Y values in Tables 9 to 12.

Δ3 can be one value from −5.0 to 20 with step of 0.5. It can be applied to each AOA offset independently. In the tables, Δ3 of ‘0’ is assumed.

For another example, the followings may be considered for the requirements.

The followings were agreed in [R4-2310491].

### 1) UE Capability for Different Performance Levels

No UE capability will be specified.

The implementations of two equally and unequally capable antenna modules could be considered when specifying the requirements.

### 2) UE Orientation for Requirement Derivation

The following aspects apply:
1. UE requirement applies to UE declared orientation(s).
2. The UE RF requirement is derived assuming each UE is evaluated in the orientation that yields the best metric value.
3. Candidate orientations for UE to choose from are all the ‘Alignment Options’ in Annex J (J.2) of 38.101-2 V18.0.0.

### 3) AoA Offsets to be Specified for the UE RF Requirement

FFS. 180 degree offset is still included in simulation.

Option 1: UE vendors may declare 2 AoA offsets for meeting requirement, one from {30, 60, 90} and one from {120, 150} respectively

Option 2:2 AoA offsets may be specified in the standard as test conditions, ex; 60 and 150 respectively.

Option 3: UE vendors may declare 1 AoA offset from {30, 60, 90, 120, 150} for meeting requirement.

Option 4: requirements for 2 AoA offsets may be specified, e.g. 60 and 150. UE vendors can declare which offset to test for meeting the requirement.

Option 5: requirements for 2 AoA offset ranges may be specified, one for {30, 60, 90} and the other for {120, 150}. UE vendors can declare only one offset to test for meeting the requirement of the corresponding range.

Regarding the agreements of [R4-2310491],

The implementations of two equally and unequally capable antenna modules could be considered when specifying the requirements.

The UE RF requirement is derived assuming each UE is evaluated in the orientation that yields the best metric value.

Based on the simulation results of FIGS. 14a and 14b, FIGS. 15a and 15b, and FIGS. 16a and 16b, the pass ratio can be calculated as follows.

$$Pass ratio = min ( pass ratio for left \& right - side , pass ratio for left \& top - side )$$

$$For each left \& right - side and left \& top - side$$

$$pass ratio = min ( Case 1 pass ratio , Case 2 pass ratio , Case 3 pass ratio )$$

$$Case 1 pass ratio = max ( X - axis oriented pass ratio , Y - axis oriented pass ratio , Z - axis oriented pass ratio )$$

$$Case 2 pass ratio = max ( X - axis oriented pass ratio , Y - axis oriented pass ratio , Z - axis oriented pass ratio )$$

$$Case 3 pass ratio = max ( X - axis oriented pass ratio , Y - axis oriented pass ratio , Z - axis oriented pass ratio )$$

Table 13 shows the summary of the Pass ratio of ‘OR combining’ and ‘averaging’ respectively.

TABLE 13

| | |
|---|---|
| AoA Offset | Pass Ratio (%) |

| (Degree) | OR combining | Averaging |
|---|---|---|
| 30 | 61.9 | 24.5 |
| 60 | 39.9 | 28.6 |
| 90 | 40.2 | 28.0 |
| 120 | 35.8 | 26.2 |
| 150 | 44.0 | 35.4 |
| 180 | 44.3 | 29.9 |

Table 13 shows examples of pass ratio for OR combining and Averaging.

The followings are observed based on Table 13.

Observation 5-6: Pass ratio of OR combining method is higher than that of averaging method.

Observation 5-7: In case of OR combining method, pass ratio is:
about 60% for 2AOA offset of 30°
from 35% to 45% for 2 AOA offsets of 60°, 90°, 120°, 150°, and 180°.

Based on the observations, the pass ratio requirement can be proposed as Table 14 based on OR combining by considering implementation margin.

TABLE 14

| AoA Offset (Degree) | Pass Ratio: Y (%) |
|---|---|
| 30 | 50 |
| 60 | 30 |
| 90 | 30 |
| 120 | 30 |
| 150 | 30 |
| 180 | 30 |

Table 14 shows examples of pass ratio for OR combining.

Proposal 5-9: the pass ratio requirement may be defined based on OR combining.

Proposal 5-10: Consider Table 14 as the pass ratio requirement for simultaneous DL reception.

Or, the following can be considered.

Table 15 may be defined based on OR combining by considering implementation margin.

TABLE 15

| AoA Offset (Degree) | Pass Ratio: Y (%) |
|---|---|
| 30 | 55 |
| 60 | 35 |
| 90 | 35 |
| 120 | 30 |
| 150 | 40 |
| 180 | 40 |

Table 15 shows examples of pass ratio for OR combining based on implementation margin.

Or, the following can be considered.

Table 16, or Table 17 may be defined based on OR combining by considering implementation margin and fixed DL power reference.

TABLE 16

| | Fixed DL power (dBm)/Channel bandwidth | | | | | | | | | |
|---|---|---|---|---|---|---|---|---|---|---|
| Operating | 50 | 100 | 200 | 400 | Pass Ratio(Y)[%]/AOA Offset (degree) | | | | | |
| band | MHz | MHz | MHz | MHz | 30° | 60° | 90° | 120° | 150° | 180° |
| n257 | −77.4 | −74.4 | −71.4 | −68.4 | 50 | 30 | 30 | 30 | 30 | 30 |
| n258 | −77.4 | −74.4 | −71.4 | −68.4 | 50 | 30 | 30 | 30 | 30 | 30 |
| n259 | −71.9 | −68.9 | −65.9 | −62.9 | TBD | TBD | TBD | TBD | TBD | TBD |
| n260 | −73.1 | −70.1 | −67.1 | −64.1 | TBD | TBD | TBD | TBD | TBD | TBD |
| n261 | −77.4 | −74.4 | −71.4 | −68.4 | 50 | 30 | 30 | 30 | 30 | 30 |
| n262 | −69.7 | −66.7 | −63.7 | −60.7 | TBD | TBD | TBD | TBD | TBD | TBD |

NOTE 1:
The transmitter shall be set to P_{UMAX} as defined in clause 6.2.4
NOTE 2:
The EIS spherical coverage requirements of 2 AOA offsets are verified only under normal thermal conditions as defined in Annex E.2.1.
NOTE 3:
UE shall meet at least two AOA offsets. One is from {30°, 60°, 90°} and another is from {120°, 150°, 180°}.

Table 16 shows examples of pass ratio based on implementation margin and fixed DL power reference.

TABLE 17

| | Fixed DL power (dBm)/Channel bandwidth | | | | | | | | | |
|---|---|---|---|---|---|---|---|---|---|---|
| Operating | 50 | 100 | 200 | 400 | Pass Ratio(Y)[%]/AOA Offset (degree) | | | | | |
| band | MHz | MHz | MHz | MHz | 30° | 60° | 90° | 120° | 150° | 180° |
| n257 | −77.4 | −74.4 | −71.4 | −68.4 | 55 | 35 | 35 | 30 | 40 | 40 |
| n258 | −77.4 | −74.4 | −71.4 | −68.4 | 55 | 35 | 35 | 30 | 40 | 40 |
| n259 | −71.9 | −68.9 | −65.9 | −62.9 | TBD | TBD | TBD | TBD | TBD | TBD |
| n260 | −73.1 | −70.1 | −67.1 | −64.1 | TBD | TBD | TBD | TBD | TBD | TBD |
| n261 | −77.4 | −74.4 | −71.4 | −68.4 | 55 | 35 | 35 | 30 | 40 | 40 |
| n262 | −69.7 | −66.7 | −63.7 | −60.7 | TBD | TBD | TBD | TBD | TBD | TBD |

NOTE 1:
The transmitter shall be set to P_{UMAX} as defined in clause 6.2.4
NOTE 2:
The EIS spherical coverage requirements of 2 AOA offsets are verified only under normal thermal conditions as defined in Annex E.2.1.
NOTE 3:
UE shall meet at least two AOA offsets. One is from {30°, 60°, 90°} and another is from {120°, 150°, 180°}.

Table 17 shows examples of pass ratio based on implementation margin and fixed DL power reference.

In above Tables 14 to 17, additional margin of ‘44’ can be considered on top of the value Y.
Δ4 can be one value from −10.0 to 10 with step of 0.5. It can be applied to each AOA offset independently. In the tables, Δ4 of ‘0’ is assumed.

If Averaging is considered, the pass ratio requirement can be proposed as Table 18, or Table 19 by considering implementation margin.

TABLE 18

| AoA Offset (Degree) | Pass Ratio: Y (%) |
|---|---|
| 30 | 20 |
| 60 | 25 |
| 90 | 25 |
| 120 | 20 |
| 150 | 30 |
| 180 | 30 |

Table 18 shows examples of pass ratio based on implementation margin.

TABLE 19

| AoA Offset (Degree) | Pass Ratio: Y (%) |
|---|---|
| 30 | 20 |
| 60 | 20 |
| 90 | 20 |
| 120 | 20 |
| 150 | 30 |
| 180 | 30 |

Table 19 shows examples of pass ratio based on implementation margin.

Proposal 5-11: the pass ratio requirements may be defined based on Averaging.

Proposal 5-12: Consider Table 18, or Table 19 as the pass ratio requirement for simultaneous DL reception

Or, the following may be considered.

Table 20, or Table 21 may be defined based on Averaging by considering implementation margin and fixed DL power reference.

TABLE 20

| | Fixed DL power (dBm)/Channel bandwidth | | | | | | | | | |
|---|---|---|---|---|---|---|---|---|---|---|
| Operating | 50 | 100 | 200 | 400 | Pass Ratio(Y)[%]/AOA Offset (degree) | | | | | |
| band | MHz | MHz | MHz | MHz | 30° | 60° | 90° | 120° | 150° | 180° |
| n257 | −77.4 | −74.4 | −71.4 | −68.4 | 20 | 25 | 25 | 20 | 30 | 30 |
| n258 | −77.4 | −74.4 | −71.4 | −68.4 | 20 | 25 | 25 | 20 | 30 | 30 |
| n259 | −71.9 | −68.9 | −65.9 | −62.9 | TBD | TBD | TBD | TBD | TBD | TBD |
| n260 | −73.1 | −70.1 | −67.1 | −64.1 | TBD | TBD | TBD | TBD | TBD | TBD |
| n261 | −77.4 | −74.4 | −71.4 | −68.4 | 20 | 25 | 25 | 20 | 30 | 30 |
| n262 | −69.7 | −66.7 | −63.7 | −60.7 | TBD | TBD | TBD | TBD | TBD | TBD |

NOTE 1:
The transmitter shall be set to P_{UMAX} as defined in clause 6.2.4
NOTE 2:
The EIS spherical coverage requirements of 2 AOA offsets are verified only under normal thermal conditions as defined in Annex E.2.1.
NOTE 3:
UE shall meet at least two AOA offsets. One is from {30°, 60°, 90°} and another is from {120°, 150°, 180°}.

Table 20 shows examples of pass ratio based on Averaging by considering implementation margin and fixed DL power reference.

TABLE 21

| | Fixed DL power (dBm)/Channel bandwidth | | | | | | | | | |
|---|---|---|---|---|---|---|---|---|---|---|
| Operating | 50 | 100 | 200 | 400 | Pass Ratio(Y)[%]/AOA Offset (degree) | | | | | |
| band | MHz | MHz | MHz | MHz | 30° | 60° | 90° | 120° | 150° | 180° |
| n257 | −77.4 | −74.4 | −71.4 | −68.4 | 20 | 20 | 20 | 20 | 30 | 30 |
| n258 | −77.4 | −74.4 | −71.4 | −68.4 | 20 | 20 | 20 | 20 | 30 | 30 |
| n259 | −71.9 | −68.9 | −65.9 | −62.9 | TBD | TBD | TBD | TBD | TBD | TBD |
| n260 | −73.1 | −70.1 | −67.1 | −64.1 | TBD | TBD | TBD | TBD | TBD | TBD |
| n261 | −77.4 | −74.4 | −71.4 | −68.4 | 20 | 20 | 20 | 20 | 30 | 30 |
| n262 | −69.7 | −66.7 | −63.7 | −60.7 | TBD | TBD | TBD | TBD | TBD | TBD |

NOTE 1:
The transmitter shall be set to P_{UMAX} as defined in clause 6.2.4
NOTE 2:
The EIS spherical coverage requirements of 2 AOA offsets are verified only under normal thermal conditions as defined in Annex E.2.1.
NOTE 3:
UE shall meet at least two AOA offsets. One is from {30°, 60°, 90°} and another is from {120°, 150°, 180°}.

Table 21 shows examples of pass ratio based on Averaging by considering implementation margin and fixed DL power reference.

In above Tables 18 to 21, additional margin of ‘45’ can be considered on top of the value Y.
Δ5 can be one value from −10.0 to 10 with step of 0.5. It can be applied to each AOA offset independently. In the tables, Δ5 of ‘0’ is assumed.

The pass ratio can apply to the UE which two antenna modules are implemented with other different locations.

Case 6: Only verify the UE functionality (e.g., go or no-go) under two AoAs with a fixed DL power level. If min[SINR_AoA1, SINR_AoA2]>=−1 dB, PASS, otherwise, FAIL. The requirements can be defined by averaging the Pass ratios of 3 UE oriented axes.

RF requirements based on case 6 may be explained.

The simulation of pass ratio over the whole sphere is performed by considering different antenna module performances, different UE orientations, and different antenna module combinations. The simulation is performed based on FIGS. 13a and 13b.

### —Antenna Module Performance:

Case 1 (Case 1 of Case 6): antenna module #1 and antenna module #2 are assumed to have the same performance gain
Case 2 (Case 2 of Case 6):: antenna module #1 is assumed to have 3 dB lower performance gain than antenna module #2
Case 3 (Case 3 of Case 6):: antenna module #2 is assumed to have 3 dB lower performance gain than antenna module #1

### —Ue Orientation:

Z-axis oriented;
Y-axis oriented;
X-axis oriented.
Probes are located in the xz plane in FIG. 13a.

### —Antenna Module Combination:

Panel_A: left-side & right-side combination (panels facing opposite directions);
Panel_B: left-side & top-side combination (panels in adjacent sides);
Panel_C: left-side & left-side combination (panels in same sides).

For each panel_A, panel_B, and panel_C, the pass ratio can be calculated as follows.

$$pass ratio = min ( Case 1 pass ratio , Case 2 pass ratio , Case 3 pass ratio ) :$$

$$Case 1 pass ratio ( pass ratio of Case 1 in Case 6 ) = max ( X - axis oriented pass ratio , Y - axis oriented pass ratio , Z - axis oriented pass ratio )$$

$$Case 2 pass ratio ( pass ratio of Case 2 in Case 6 ) = max ( X - axis oriented pass ratio , Y - axis oriented pass ratio , Z - axis oriented pass ratio )$$

$$Case 3 pass ratio ( pass ratio of Case 3 in Case 6 ) = max ( X - axis oriented pass ratio , Y - axis oriented pass ratio , Z - axis oriented pass ratio )$$

Following assumptions may be considered for case 6.

Considered simulation assumption are based on the following:

number (#) of antenna module=2, dual polarized. array of element antenna in each antenna module=4×1.

UE assigns ‘first’ module to track TRP that yields highest RSRP among all combinations of modules and TRPs. The best of the other modules is assigned to track the other TRP.

Pass/Fail criterion.

If min [SINR_AoA1, SINR_AoA2]>=−1 dB, PASS, otherwise, FAIL

For a specific angular separation between 2 TRPs and a specific UE orientation under standardized DL power level which is equal between 2 TRPs, the result at each test point is constructed based on two AoA pairs containing that test point, i.e., AoA+ pair and AoA− pair. Overall result (probability to support 2TRP DL) is by averaging regional results

Area weight type for spatial average (for constant-step grid). sin*?* is used for summing or averaging data collected on a lat-long grid.

Both DL powers are same as the legacy spherical coverage EIS requirement as starting point

Scale the antenna gain to make UE align with both the legacy peak EIS and spherical coverage requirements

$$Noise ( dBm ) = - 174 + 10 * log 10 ( CBW ) + NF .$$

$$Herein , CBW = 100 MHz , NF = 10.$$

### Aoa Offsets:

30°, 60°, 90°, 120°, 150°, 180°;

$$Band = n 257 .$$

Considered simulation procedure may be based on the following 1 to 10. Simulations are performed based on the following 1 to 10.
1. For one UE implementation
2. For one UE orientation
3. Run Electromagnetic (EM) simulation to obtain per-beam antenna gain patterns
Constant step size is suggested <=5°
Performance difference between V/H element can be considered
Normalize antenna gain to align with the gain drop between peak EIS and spherical coverage in current spec.
4. For one angular separation
5. For one test grid point in 3D scan

### Select Beam Based on RSRP

5.1 Calculate SINR of AoA+ and AoA− respectively
SINR=P_signal/(Noise+P_interf)

Where the P_signal is the power of wanted signal and the P_interf is the power of interference, Noise (dBm)=−174+10*log 10 (CBW) +NF, CBW is channel bandwidth, NF=10
5.2 If SINR>=−1, PASS, otherwise, FAIL
5.3a OR combining the results of AoA+ and AoA−.

Herein, AoA+ means that changing angles of the UE to + angle with respect to 1st direction (e.g., clockwise). AoA− means that changing angles of the UE to + angle with respect to 1st direction (e.g., counter clockwise).
5.3b No logic combination of the results of AoA+ and AoA−, but treat them as two separate points
(e.g., arithmetic mean)
Other methods for +/− offset data are not precluded
Companies are encouraging to provide analysis on the pros and cons for each “combination” method
5.4 Add weighting (sin θ or Clenshaw-Curtis Quadrature)
6. Repeat for other test grid point
7. Calculate the spherical coverage percentage
8. Repeat for other angular separation
9. Repeat for other UE orientations
10. Repeat for other UE implementations

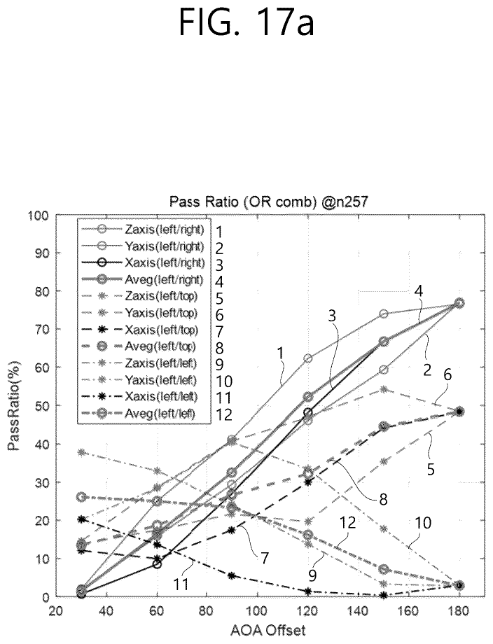

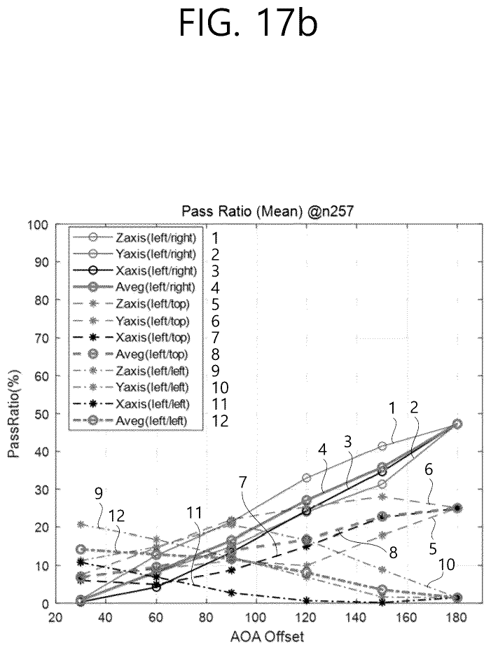

FIGS. 17a and 17b, FIGS. 18a and 18b, and FIGS. 19a and 19b show the results of the pass ratio of both OR combining and arithmetic mean for Case1, Case2, and Case3, respectively. Herein, arithmetic mean may mean averaging.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

FIGS. 17a and 17b illustrate examples of Pass Ratio of both ‘OR combining’ and ‘arithmetic mean for Case 1 of Case 6 according to an embodiment of the present disclosure.

FIG. 17a is an example of pass ratio based on OR combining.

FIG. 17b is an example of pass ratio based on arithmetic mean.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

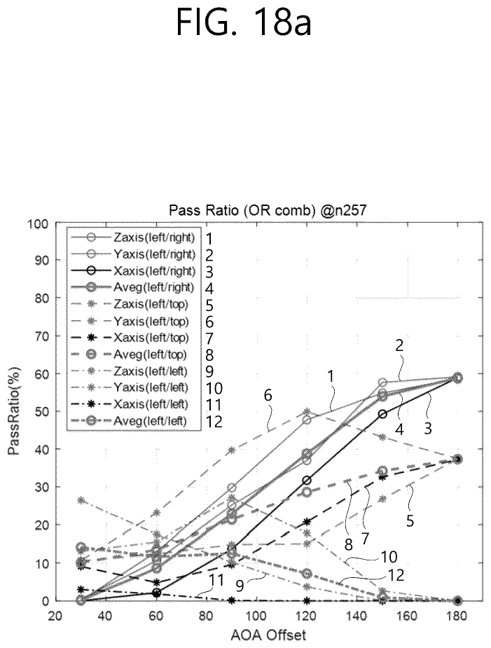

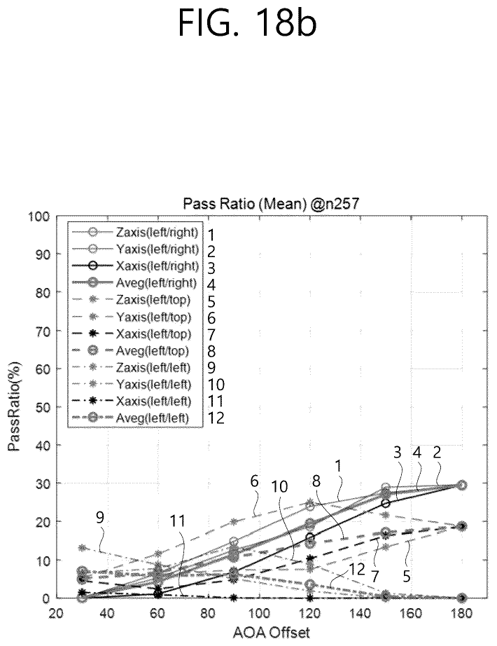

FIGS. 18a and 18b illustrate examples of Pass Ratio of both ‘OR combining’ and ‘arithmetic mean for Case 2 of Case 6 according to an embodiment of the present disclosure.

FIG. 18a is an example of pass ratio based on OR combining.

FIG. 18b is an example of pass ratio based on arithmetic mean.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

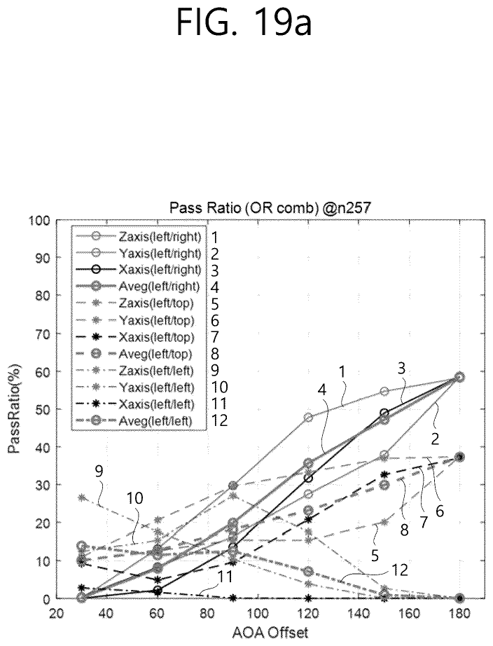

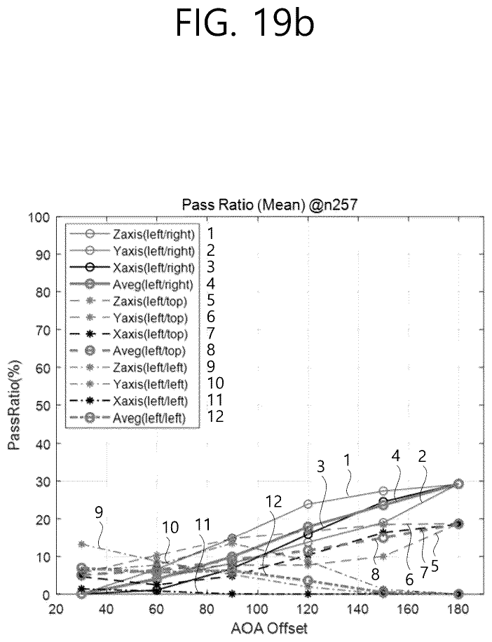

FIGS. 19a and 19b illustrate examples of Pass Ratio of both ‘OR combining’ and ‘arithmetic mean for Case 3 of Case 6 according to an embodiment of the present disclosure.

FIG. 19a is an example of pass ratio based on OR combining.

FIG. 19b is an example of pass ratio based on arithmetic mean.

In FIGS. 17a to 19b, 1 shows pass ratio based on Zaxis(left/right), 2 shows pass ratio based on Yaxis(left/right), 3 shows pass ratio based on Xaxis(left/right), 4 shows pass ratio based on Average value (Aveg)(left/right). 5 shows pass ratio based on Zaxis(left/top), 6 shows pass ratio based on Yaxis(left/top), 7 shows pass ratio based on Xaxis(left/top), 8 shows pass ratio based on Average value (Aveg)(left/top). 9 shows pass ratio based on Zaxis(left/left), 10 shows pass ratio based on Yaxis(left/left), 11 shows pass ratio based on Xaxis(left/left), 12 shows pass ratio based on Average value (Aveg)(left/left).

Based on FIGS. 17a to 19b, Tables 22 and 23 are derived. Table 22 and Table 23 show the Pass ratio of ‘arithmetic mean’ and ‘OR combining’ respectively.

TABLE 22

| | 30° | 60° | 90° | 120° | 150° | 180° |
|---|---|---|---|---|---|---|
| panels facing | 0.2 | 6.5 | 14.9 | 23.9 | 27.3 | 29.3 |
| opposite | (worst) | (worst) | (best) | (best) | (best) | (best) |
| directions | | | | | | |
| panels in | 5.3 | 10.3 | 14.8 | 16.6 | 18.5 | 18.7 |
| adjacent sides | | (best) | | | | |
| panels in same | 13.2 | 8.7 | 13.5 | 8.7 | 1.3 | 0.0 |
| side | (best) | | (worst) | (worst) | (worst) | (worst) |

Table 22 shows example of Pass ratio (%) with ‘arithmetic mean’ based on simulation results of FIGS. 17a to 19b.

TABLE 23

| | 30° | 60° | 90° | 120° | 150° | 180° |
|---|---|---|---|---|---|---|
| panels facing | 0.4 | 13.0 | 29.7 | 47.7 | 54.7 | 58.6 |
| opposite | (worst) | (worst) | (best) | (best) | (best) | (best) |
| directions | | | | | | |
| panels in | 10.6 | 20.6 | 29.5 | 33.2 | 36.9 | 37.4 |
| adjacent sides | | (best) | | | | |
| panels in same | 26.4 | 17.5 | 27.0 | 17.5 | 2.7 | 0.0 |
| side | (best) | | (worst) | (worst) | (worst) | (worst) |

Table 23 shows example of Pass ratio with ‘OR’ based on simulation results of FIGS. 17a to 19b.

Table 24 shows examples of the best Pass Ratio and the worst Pass Ratio between different panels which are written in Tables 22 and 23 with (worst) (best), respectively.

TABLE 24

| | Best Pass Ratio (%) | | Worst Pass Ratio (%) | |
|---|---|---|---|---|
| AoA Offset | Arithmetic | OR | Arithmetic | OR |
| (Degree) | mean | combining | mean | combining |
| 30 | 13.2 | 26.4 | 0.2 | 0.4 |
| 60 | 10.3 | 20.6 | 6.5 | 13.0 |
| 90 | 14.9 | 29.7 | 13.5 | 27.0 |
| 120 | 23.9 | 47.7 | 8.7 | 17.5 |
| 150 | 27.3 | 54.7 | 1.3 | 2.7 |
| 180 | 29.3 | 58.6 | 0.0 | 0.0 |

Table 24 shows examples of best/worst pass ratio based on tables 22 and 23.

Table 25 shows the difference of Pass Ratio between above 3 panel implementations. 3 panel implementation may include panel_A, panel_B, panel_C:
Panel_A: left-side & right-side combination (panels facing opposite directions);
Panel_B: left-side & top-side combination (panels in adjacent sides);
Panel_C: left-side & left-side combination (panels in same sides).

TABLE 25

| | |
|---|---|
| AoA Offset | Difference of Pass Ratio |

| (Degree) | Arithmetic mean | OR combining |
|---|---|---|
| 30 | 13.0 | 26.0 |
| 60 | 3.8 | 7.6 |
| 90 | 1.4 | 2.7 |
| 120 | 15.1 | 30.2 |
| 150 | 26.0 | 52.0 |
| 180 | 29.3 | 58.6 |

Table 25 shows Difference of Pass Ratio between panel implementations.

The followings are observed based on examples explained above based on Case 6.

Observation 6-1: Pass ratio of OR combining method is higher than that of arithmetic mean method.

Observation 6-2: The difference of Pass ratio between AOA offsets is lower in arithmetic mean method.

Observation 6-3: The difference of Pass ratio between panel implementations is the lowest in AOA offset of 90°.

For options of the requirements,
Option 1: Define a requirement for each candidate AoA offset
Option 2: The requirement is defined for just 1 AoA offset

For option 1, it is proposed to define the requirement for each candidate AOA offset considering the best Pass Ratio.

For option 2, it is proposed to define the requirement for just AOA offset of 90° because the difference of Pass Ratio between panel implementation is the lowest as observation 3.

Proposal 6-1: If option 1 is considered, define the requirement for each candidate AOA offset considering the best Pass Ratio. Table 26 can be one example of the requirement.

Proposal 6-2: If option 2 is considered, define the requirement for just AOA offset of 90°. Table 27 can be one example of the requirement.

For example, the requirement can be as Table 26 for option 1, and as Table 27 for option 2 by considering implementation margin.

TABLE 26

| | |
|---|---|
| AoA Offset | Pass Ratio (%) [Y] |

| (Degree) | Arithmetic mean | OR combining |
|---|---|---|
| 30 | 11 | 24 |
| 60 | 8 | 18 |
| 90 | 12 | 27 |
| 120 | 22 | 45 |
| 150 | 25 | 50 |
| 180 | 25 | 50 |

Table 26 shows examples of pass ratio based on the option 1.

TABLE 27

| | |
|---|---|
| AoA Offset | Pass Ratio (%)[Y] |

| (Degree) | Arithmetic mean | OR combining |
|---|---|---|
| 90 | 12 | 27 |

Table 27 shows examples of pass ratio based on the option 2.

Or, requirements may be defined as the following:

For example, the requirement may be defined as Table 28 for option 1, and as Table 29 for option 2 by considering implementation margin.

TABLE 28

| | |
|---|---|
| AoA Offset | Pass Ratio (%)[Y] |

| (Degree) | Arithmetic mean | OR combining |
|---|---|---|
| 30 | 10 | 20 |
| 60 | 10 | 20 |
| 90 | 12 | 25 |
| 120 | 20 | 30 |
| 150 | 20 | 30 |
| 180 | 20 | 30 |

Table 28 shows examples of Pass ratio based on option 1.

TABLE 29

| | |
|---|---|
| AoA Offset | Pass Ratio (%)[Y] |

| (Degree) | Arithmetic mean | OR combining |
|---|---|---|
| 90 | 12 | 25 |

Table 29 shows examples of Pass ratio based on option 2.

Or, requirements may be defined as the following:

For example, the requirement can be as Table 30 for option 1, and as Table 31 for option 2 by consider implementation margin.

TABLE 30

| | |
|---|---|
| AoA Offset | Pass Ratio (%)[Y] |

| (Degree) | Arithmetic mean | OR combining |
|---|---|---|
| 30 | 10 | 20 |
| 60 | 10 | 20 |
| 90 | 10 | 25 |
| 120 | 20 | 30 |
| 150 | 20 | 30 |
| 180 | 20 | 30 |

Table 30 shows examples of Pass ratio based on option 1.

TABLE 31

| | |
|---|---|
| AoA Offset | Pass Ratio (%)[Y] |

| (Degree) | Arithmetic mean | OR combining |
|---|---|---|
| 90 | 10 | 25 |

Table 31 shows examples of Pass ratio based on option 2.

In above Tables 26 to Table 30 Table 29 31 additional margin of ‘Δ6’ can be considered on top of the value Y.
Δ6 can be one value from −5 to 15 with step of 0.5. It can be applied to each AOA offset independently. In the tables, Δ6 of ‘0’ is assumed.

The pass ratio can apply to the UE which two antenna modules are implemented with other different locations.

Additional simulation results may be considered as the following. (results after calibration with spherical coverage 50% without margin from simulation data)

Table 32 and Table 33 show the Pass ratio of ‘arithmetic mean’ and ‘OR combining’ respectively.

TABLE 32

| | 30° | 60° | 90° | 120° | 150° | 180° |
|---|---|---|---|---|---|---|
| panels facing | 0.0 | 1.7 | 9.8 | 19.2 | 20.0 | 23.0 |
| opposite | | | | | | |
| directions | | | | | | |
| panels in | 4.1 | 8.1 | 12.5 | 12.3 | 14.1 | 14.3 |
| adjacent sides | | | | | | |
| panels in same | 9.4 | 6.5 | 10.7 | 3.3 | 0.0 | 0.0 |
| side | | | | | | |

Table 32 shows pass ratio (%) based on ‘arithmetic mean’.

TABLE 33

| | 30° | 60° | 90° | 120° | 150° | 180° |
|---|---|---|---|---|---|---|
| panels facing | 0.0 | 3.3 | 19.6 | 38.4 | 39.9 | 46.3 |
| opposite | | | | | | |
| directions | | | | | | |
| panels in | 8.2 | 16.3 | 24.9 | 24.5 | 28.2 | 28.6 |
| adjacent sides | | | | | | |
| panels in same | 18.8 | 13.0 | 21.5 | 6.6 | 0.0 | 0.0 |
| side | | | | | | |

Table 33 shows pass ratio (%) based on ‘OR combining’.

Table 34 shows examples of the pass ratio for UE declaration of AoA offset.

TABLE 34

| AoA offset (degrees) | 30° | 60° | 90° | 120° | 150° |
|---|---|---|---|---|---|
| Reference UE | same | same | adjacent | opposite | opposite |
| Pass Ratio | 9.4 | 6.5 | 12.5 | 19.2 | 20.0 |
| [Arithmetic mean] (%) | | | | | |
| Pass Ratio | 18.8 | 13.0 | 24.9 | 38.4 | 39.9 |
| [OR combining] (%) | | | | | |

Table 34 shows Pass ratio for UE declaration of AoA offset. For example, the UE may declare the AoA offset when the UE is tested by a test system.

Table 35 shows the pass ratio for standard specification of AoA offset.

TABLE 35

| AoA offset (degrees) | 30° | 60° | 90° | 120° | 150° |
|---|---|---|---|---|---|
| Reference UE | Min (same, adjacent, opposite) | | | | |
| Pass Ratio | 0.0 | 1.7 | 9.8 | 3.3 | 0.0 |
| [Arithmetic mean] (%) | | | | | |
| Pass Ratio | 0.0 | 3.3 | 19.6 | 6.6 | 0.0 |
| [OR combining] (%) | | | | | |

Table 35 shows examples of Pass ratio for specification in standard.

Based on examples of the simulation results in case 6, the requirement may be defined as Table 36, and/or Table 37 by considering implementation margin.

TABLE 36

| | |
|---|---|
| AoA Offset | Pass Ratio (%)[Y] |

| (Degree) | Arithmetic mean | OR combining |
|---|---|---|
| 30 | 9.5 | 19 |
| 60 | 6.5 | 13 |
| 90 | 12.5 | 25 |
| 120 | 19.0 | 38 |
| 150 | 20.0 | 40 |

Table 36 shows examples of pass ratio based on option 1.

TABLE 37

| | |
|---|---|
| AoA Offset | Pass Ratio (%)[Y] |

| (Degree) | Arithmetic mean | OR combining |
|---|---|---|
| 90 | 10 | 20 |

Table 37 shows examples of pass ratio based on option 2.

Or, further relaxation may be applied for requirements as the following.

TABLE 38

| | |
|---|---|
| AoA Offset | Pass Ratio (%)[Y] |

| (Degree) | Arithmetic mean | OR combining |
|---|---|---|
| 30 | 18 | 30 |
| 60 | 16 | 27 |
| 90 | 16.5 | 30 |
| 120 | 22 | 38 |
| 150 | 29.5 | 42 |

Table 38 shows examples of pass ratio based on option 1, to which further relaxation is applied.

TABLE 39

| | |
|---|---|
| AoA Offset | Pass Ratio (%)[Y] |

| (Degree) | Arithmetic mean | OR combining |
|---|---|---|
| 90 | 13 | 22 |

Table 39 shows examples of pass ratio based on option 2, to which further relaxation is applied.

TABLE 40

| | |
|---|---|
| AoA Offset | Pass Ratio (%)[Y] |

| (Degree) | Arithmetic mean | OR combining |
|---|---|---|
| 30 | 18.8 | 30.1 |
| 60 | 16.1 | 27.0 |
| 90 | 16.6 | 30.2 |
| 120 | 22.4 | 38.4 |
| 150 | 29.7 | 42.0 |

Table 40 shows another examples of pass ratio based on option 1, to which further relaxation is applied.

TABLE 41

| | |
|---|---|
| AoA Offset | Pass Ratio (%)[Y] |

| (Degree) | Arithmetic mean | OR combining |
|---|---|---|
| 90 | 13 | 22.3 |

Table 41 shows another examples of pass ratio based on option 2, to which further relaxation is applied.

In above Tables 36 to 41 additional margin of ‘Δ7’ can be considered on top of the value Y.
Δ7 can be one value from −5 to 15 with step of 0.5 or with step of 0.1 It can be applied to each AOA offset independently. In the tables, Δ7 of ‘0’ is assumed.

For example, Δ7 may be applied to Table 36. Based on examples of Δ7 applied to Table 36, Table 42 is derived.

TABLE 42

| AoA separation | Probability |
|---|---|
| (degrees) | (%) |
| 30 | 18.5 |
| 60 | 13.5 |
| 90 | 12.5 |
| 120 | 20.5 |
| 150 | 28.5 |

For example, AoA offset means AoA separation. In present disclosure, pass ratio means probability of Table 42. Herein, Table 42 is based on averaging. For example, The probability may be defined as the spatial average over the full sphere around the UE of the probability of any one direction to support 2 AoA reception. In the applicable test system, the probability of any one direction of the UE to support 2 AoA reception for any specific AoA separation is the ratio of the number of unique AoA pairs that include that direction and can support 2 AoA reception to the total number of verified unique AoA pairs that include that direction.

Table 42 may be Requirement for power class 3. The requirements may be included in Spherical coverage requirement for simultaneous reception from multiple directions may include 2AoA spherical coverage of power class 3. Spherical coverage requirement for simultaneous reception from multiple directions may applied to the UE may include Spherical coverage requirement for simultaneous reception from multiple directions may include 2AoA spherical coverage of power class 3.

The requirement may apply to FR2-1 UEs that support a capability including simultaneousReceptionDiffTypeD.

Pass Ratio is proposed to be defined with either ‘arithmetic mean’ or ‘OR combining’. The corresponding pass ratio in the above tables are applied.

Or Pass Ratio is proposed to be defined with both ‘arithmetic mean’ and ‘OR combining’, and to be tested with either one.

The following examples are related information considered in Cases 1 to 6

### 1.1 Data Process Method on Companies' Input

1. There are 9 starting UE orientation options per annex J ofTS38.101-2 V 18.0.0 for multiRX.
2. Realistic packaging including metal and plastic housings, as well as H and V imbalance may be considered.
3. Three types of reference UE implementation (two panels on the same side, two panels on the adjacent side and two panels on the opposite side) will be used to determine the core requirement:

TABLE 43

| AoA offset | | | | | |
|---|---|---|---|---|---|
| (degrees) | 30 | 60 | 90 | 120 | 150 |
| Reference | same | same | adjacent | opposite | opposite |
| UE | | | | | |

Table 43 shows examples of AoA offset (e.g., AoA separation) may be declared by a UE.

TABLE 44

| AoA offset | | | | | |
|---|---|---|---|---|---|
| (degrees) | 30° | 60° | 90° | 120° | 150° |
| Reference | Min | Min | Min | Min | Min |
| UE | (same, | (same, | (same, | (same, | (same, |
| | adjacent, | adjacent, | adjacent, | adjacent, | adjacent, |
| | opposite) | opposite) | opposite) | opposite) | opposite) |

Table 44 shows examples of the AoA offset that can be specified in the standard.

### 1.2 Combining Method

Option 1—arithmetic mean
Option 2—OR combining

### 1.3 AoA Offset

Further discuss if the AoA offset should be declared by UE or specified in the standard

### 1.4 Additional RF Impairment for 30 Degree and 60 Degree AoA Offsets

Companies are allowed to provide further analysis if sufficient margin has been taken into account for 30 and 60 degrees AoA offsets

The following assumptions may be considered.

### General Deployment Assumption for DL Split Between TRPs to Enable 4L Reception

Proposal: To support 4L DL MIMO reception at the UE when configured with 2 active TCI states, polarization multiplex (2 layers/direction)+spatial multiplex (2 directions) is assumed at the UE.

Note: This proposal is for general deployment assumption, not aimed at UE RF assumption

### Scope Definition for UE RF Requirements

Proposal: UE RF requirements for simultaneous reception from different directions shall be based on single-layer reception for each DL direction with dual TCI configuration, i.e., total 2 layers for both directions

DCI scheme when UE is configured for 2 active TCI states for UE RF requirements

Proposal: For setting the UE RF requirement when the UE is configured with 2 active TCI states, single DCI scheme is adopted as a baseline.

The following description is from R4-2303708, considered for the examples of the present disclosure.

2TRP grid for UE performance evaluation is considered.

The 2TRP data set is only complete when each TRP traverses the entire surface of the test sphere.

For optimized AoA1 and AoA2 test point/perceived DL direction coverage, apply a full rotation in θ and a half rotation in Φ. For optimized AoA1 and AoA2 test point/perceived DL direction coverage, utilize constant-step size grids only.

In the coordination system of z-axis pointing to AoA1 (P0), the two AoAs (probes) shall be located in xz plane

Testing both +AoA offset and −AoA offset for each test point shall be the starting point for simulation. The intention is to accommodate the impact from directionality of the AoA1-AoA2 DL orientation vectors. In other words we want to ensure no testing bias is introduced.

Requirement Concept for UE RF is considered.

May use Option 3 as baseline.

Companies can also provide the evaluation for Option 1 and Option 5.

FFS on details for requirement concept e.g., DL power level in Option 3, in section 1.2.9

Option 3: Only verify the UE functionality (e.g., go or no-go) under two AoAs with a fixed DL power level. In other words, the UE can achieve EIS performance not worse than YdBm on the test point pair (corresponding to 2 AoAs) and the ratio of qualified test points over the whole sphere is M %.

UE orientation during verification or simulation

Agreement is based on the following:

UE orientation w.r.t P0 position (z-axis) is part of core requirement consideration.

In the simulation, RAN4 should study all the orientations

AoA separation for UE RF requirement

Agreement is based on the following:

AoA offset value should be an integer multiple of the step size of the constant step size measurement test grid.

In the simulation, all AoA separation values in the list {30°, 60°, 90°, 120°, 150°, 180°} shall be simulated

UE Simulation Assumptions

Agreement is based on the following:

Simulation output: Statistics per TRP (further combining not precluded from final requirement)

Y %@legacy EIS spherical coverage value in dBm as baseline

X dBm for legacy coverage fraction (example PC1=15%, PC3=50%) in 2TRP operation is encouraged based on contribution driven for the sake of comparison

For mDCI, if any one of the two test directions in a pair fails, the result is a fail for the AoA pair.

antenna module assumptions:

table 45 may be considered.

company choice on bias, antenna module location, module count, antenna gain, but legacy spherical coverage requirement must be met.

TABLE 45

| | Simulation | |
|---|---|---|
| Item | assumption | Note |
| # of antenna module | 2, dual polarized | |
| array of element | 4 × 1 | |
| antenna in each | | |
| antenna module | | |
| Antenna location | combination of | Two antenna modules |
| (front, back, top- | the lists | located at same side |
| side, left-side, | (e.g., left and | is not precluded |
| right-side, | right, Right and | |
| bottom-side) | Top, Left and | |
| | top, .etc.) | |

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

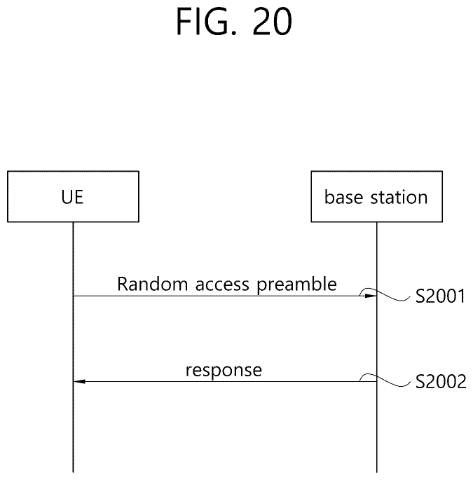

FIG. 20 illustrates an example of an operation according to an embodiment of the present disclosure.

In addition, the operation of the UE and the base station shown in the example of FIG. 20 is only an example. The operation of the UE is not limited by the example of FIG. 20, and the UE and the base station may perform the operations described in various examples of the present specification.

In step S2001, the UE may transmit random access preamble to a base station.

In step S2002, the base station may transmit a response message to the UE.

The UE may be configured to satisfy spherical coverage requirements for simultaneous reception from multiple directions. The spherical coverage requirements include requirements related to 2 Angle of Arrival (AoA) spherical. The requirements related to 2 AoA spherical includes minimum required overall probability to support 2 AoA reception. For AoA separation being 90 degrees, wherein the minimum required overall probability is equal to 12.5%, based on that (i) the UE is power class 3 UE and (ii) the UE supports simultaneous reception.

The probability may be based on a spatial average over a full sphere around the UE of the probability of any one direction to support 2 AoA reception.

The requirements related to 2 AoA spherical may be applied for the UE's declared orientation in a positioner of a test system.

For AoA separation being 30 degrees, wherein the minimum required overall probability may be equal to 18.5%, based on that (i) the UE is power class 3 UE and (ii) the UE supports simultaneous reception.

For AoA separation being 60 degrees, wherein the minimum required overall probability may be equal to 13.5%, based on that (i) the UE is power class 3 UE and (ii) the UE supports simultaneous reception.

For AoA separation being 120 degrees, wherein the minimum required overall probability may be equal to 20.5%, based on that (i) the UE is power class 3 UE and (ii) the UE supports simultaneous reception.

For AoA separation being 150 degrees, wherein the minimum required overall probability may be equal to 28.5%, based on that (i) the UE is power class 3 UE and (ii) the UE supports simultaneous reception.

The UE may further transmit capability information that the UE supports simultaneous reception with different quasi co located (QCL) Type-D to the base station.

According to examples of the present disclosure, spherical coverage requirement for simultaneous reception from multiple directions may applied to the UE.

The requirement may apply to FR2-1 UEs that support a capability including simultaneousReceptionDiffTypeD.

The requirement applies for simultaneous reception of rank 2 PDSCH, where each layer uses overlapping RBs in both time and frequency and is associated with a unique TCI state and AoA. The scheduled TCI states for the rank 2 PDSCH shall be configured with different QCL type-D reference signals respectively. The DL power at the center of quiet zone from each AoA equals the EIS spherical coverage requirement from sub-clause 7.3.4 of TS 38.101-2 V18.0.0.

Spherical coverage requirement for simultaneous reception from multiple directions may include 2AoA spherical coverage of power class 3.

Requirements related to 2AoA spherical coverage of power class 3 may apply to the UE when tested in a test system. The requirement may be verified with the test metric of throughput (Link=2AoA spherical coverage grid, Meas-Link Angle).

The spherical coverage requirement for simultaneous reception from multiple directions may apply to the probability to support simultaneous reception of rank 2 PDSCH. The probability may be defined as the spatial average over the full sphere around the UE of the probability of any one direction to support 2 AoA reception. In the applicable test system, the probability of any one direction of the UE to support 2 AoA reception for any specific AoA separation is the ratio of the number of unique AoA pairs that include that direction and can support 2 AoA reception to the total number of verified unique AoA pairs that include that direction.

The requirement applies only for the UE's declared orientation in the positioner of the test system. The requirement for each AoA separation condition applies only for the UE's declared orientation in the positioner of the test system for that AoA separation. The minimum required overall probability to support 2 AoA reception for power class 3 UEs for any channel bandwidth may be specified by AoA separation in table 42. The UE is required to fulfil the requirement at any one declared AoA separation.

The present specification may have various effects.

For example, Requirements for the introduction of devices supporting multiple RF chains in the Ultra High Frequency band can be clearly defined. Accordingly, test metrics that such a terminal must pass in order to be placed on the market may be clearly defined. For example, a terminal may satisfy the requirements proposed in the disclosure herein for effectively and/or accurately receiving signals received simultaneously from multiple directions.

The effects that may be obtained from the specific examples of this disclosure are not limited to those listed above. For example, there may be a variety of technical effects that a person having ordinary skill in the related art may understand or infer from this disclosure. Accordingly, the specific effects of the present disclosure are not limited to those expressly set forth herein, but may include a variety of effects that may be understood or inferred from the technical features of the present disclosure.

For reference, the operation of the terminal (e.g., UE) described in the present specification may be implemented by the apparatus of FIGS. 1 to 4 described above. For example, the terminal (e.g., UE) may be the first device 100 or the second device 200 of FIG. 2. For example, an operation of a terminal (e.g., UE) described herein may be processed by one or more processors 102 or 202. The operation of the terminal described herein may be stored in one or more memories 104 or 204 in the form of an instruction/program (e.g., instruction, executable code) executable by one or more processors 102 or 202. One or more processors 102 or 202 control one or more memories 104 or 204 and one or more transceivers 105 or 206, and may perform the operation of the terminal (e.g., UE) described herein by executing instructions/programs stored in one or more memories 104 or 204.

In addition, instructions for performing an operation of a terminal (e.g., UE) described in the present disclosure of the present specification may be stored in a non-volatile computer-readable storage medium in which it is recorded. The storage medium may be included in one or more memories 104 or 204. And, the instructions recorded in the storage medium may be executed by one or more processors 102 or 202 to perform the operation of the terminal (e.g., UE) described in the present disclosure of the present specification.

For reference, the operation of a network node (e.g., AMF, SMF, UPF, etc.) or base station (e.g., NG-RAN, gNB, eNB, RAN, E-UTRAN etc.) described herein may be implemented by the apparatus of FIGS. 1 to 3 to be described below. For example, a network node or a base station may be the first device 100 of FIG. 2 or the second device 200 of FIG. 2. For example, the operation of a network node or base station described herein may be processed by one or more processors 102 or 202. The operation of the terminal described herein may be stored in one or more memories 104 or 204 in the form of an instruction/program (e.g., instruction, executable code) executable by one or more processors 102 or 202. One or more processors 102 or 202 may perform the operation of a network node or a base station described herein, by controlling one or more memories 104 or 204 and one or more transceivers 106 or 206 and executing instructions/programs stored in one or more memories 104 or 204.

In addition, instructions for performing the operation of the network node or base station described in the present disclosure of the present specification may be stored in a non-volatile (or non-transitory) computer-readable storage medium. The storage medium may be included in one or more memories 104 or 204. And, the instructions recorded in the storage medium are executed by one or more processors 102 or 202, so that the operations of a network node or base station are performed.

In the above, preferred embodiments have been exemplarily described, but the present disclosure of the present specification is not limited to such specific embodiments, and thus, modifications, changes, or may be improved.

In the exemplary system described above, the methods are described on the basis of a flowchart as a series of steps or blocks, but are not limited to the order of the steps described, some steps may occur in a different order or concurrent with other steps as described above. In addition, those skilled in the art will understand that the steps shown in the flowchart are not exclusive and that other steps may be included or that one or more steps of the flowchart may be deleted without affecting the scope of rights.

The claims described herein may be combined in various ways. For example, the technical features of the method claims of the present specification may be combined and implemented as an apparatus, and the technical features of the apparatus claims of the present specification may be combined and implemented as a method. In addition, the technical features of the method claim of the present specification and the technical features of the apparatus claim may be combined to be implemented as an apparatus, and the technical features of the method claim of the present specification and the technical features of the apparatus claim may be combined and implemented as a method.

1. A user equipment (UE) comprising:
at least one transceiver;
at least one processor; and
at least one memory that stores instructions and is operably electrically connectable with the at least one processor,
wherein, based on being executed by the at least one processor, the instructions control the at least one transceiver to receive a signal from a base station,
wherein spherical coverage requirement for simultaneous reception from multiple directions applies to the UE,
wherein the spherical coverage requirement includes requirements related to 2 Angle of Arrival (AoA) spherical coverage,
wherein the requirements related to 2 AoA spherical coverage include minimum required overall probability to support 2 AoA reception,
wherein, for AoA separation being 90 degrees, the minimum required overall probability is 12.5%, based on that (i) the UE is power class 3 UE and (ii) the UE supports simultaneous reception.

2. The UE of claim 1,
wherein the minimum required overall probability is based on a spatial average over a full sphere around the UE of a probability of any one direction to support 2 AoA reception.

3. The UE of claim 1,
wherein the requirements related to 2 AoA spherical coverage apply for a declared orientation of the UE in a positioner of a test system.

4. The UE of claim 1,
wherein, for the AoA separation being 30 degrees, the minimum required overall probability is 18.5%, based on that (i) the UE is power class 3 UE and (ii) the UE supports simultaneous reception.

5. The UE of claim 1,
wherein, for the AoA separation being 60 degrees, the minimum required overall probability is 13.5%, based on that (i) the UE is power class 3 UE and (ii) the UE supports simultaneous reception.

6. The UE of claim 1,
wherein, for the AoA separation being 120 degrees, the minimum required overall probability is 20.5%, based on that (i) the UE is power class 3 UE and (ii) the UE supports simultaneous reception.

7. The UE of claim 1,
wherein, for the AoA separation being 150 degrees, the minimum required overall probability is 28.5%, based on that (i) the UE is power class 3 UE and (ii) the UE supports simultaneous reception.

8. The UE of claim 1,
wherein the at least one processor is further adapted to:
transmit capability information that the UE supports simultaneous reception with different quasi co located (QCL) Type-D.

9. A method comprising:
receiving, by a user equipment (UE), a signal from a base station,
wherein spherical coverage requirement for simultaneous reception from multiple directions applies to the UE,
wherein the spherical coverage requirement includes requirements related to 2 Angle of Arrival (AoA) spherical coverage,
wherein the requirements related to 2 AoA spherical coverage include minimum required overall probability to support 2 AoA reception,
wherein, for AoA separation being 90 degrees, the minimum required overall probability is 12.5%, based on that (i) the UE is power class 3 UE and (ii) the UE supports simultaneous reception.

10. (canceled)

11. The method of claim 9,
wherein, for the AoA separation being 30 degrees, the minimum required overall probability is 18.5%, based on that (i) the UE is power class 3 UE and (ii) the UE supports simultaneous reception.

12. The method of claim 9,
wherein, for the AoA separation being 60 degrees, the minimum required overall probability is 13.5%, based on that (i) the UE is power class 3 UE and (ii) the UE supports simultaneous reception.

13. The method of claim 9,
wherein, for the AoA separation being 120 degrees, the minimum required overall probability is 20.5%, based on that (i) the UE is power class 3 UE and (ii) the UE supports simultaneous reception.

14. The method of claim 9,
wherein, for the AoA separation being 150 degrees, wherein the minimum required overall probability is 28.5%, based on that (i) the UE is power class 3 UE and (ii) the UE supports simultaneous reception.

15. The method of claim 9, further comprising:
transmitting capability information that the UE supports simultaneous reception with different quasi co located (QCL) Type-D.

16. (canceled)

17. (canceled)

18. A method comprising:
transmitting, by a base station to a user equipment (UE), a signal,
wherein spherical coverage requirement for simultaneous reception from multiple directions applies to the UE,
wherein the spherical coverage requirement includes requirements related to 2 Angle of Arrival (AoA) spherical coverage,
wherein the requirements related to 2 AoA spherical coverage include minimum required overall probability to support 2 AoA reception,
wherein, for AoA separation being 90 degrees, the minimum required overall probability is 12.5%, based on that (i) the UE is power class 3 UE and (ii) the UE supports simultaneous reception.

19. The method of claim 18,
receiving capability information that the UE supports simultaneous reception with different quasi co located (QCL) Type-D from the UE.

20. (canceled)

21. (canceled)

22. (canceled)

23. (canceled)
